(19) United States
(12) Patent Application Publication
(10) Pub. No.: US 2024/0262536 A1
(43) Pub. Date: Aug. 8, 2024

(54) THERMOELECTROMAGNETIC SPACECRAFT PROPELLANT POSITIONING

(71) Applicant: Georgia Tech Research Corporation, Atlanta, GA (US)

(72) Inventors: Alvaro Romero Calvo, Atlanta, GA (US); Samuel Hart, Atlanta, GA (US); Edgar Glenn Lightsey, Atlanta, GA (US)

(21) Appl. No.: 18/432,295

(22) Filed: Feb. 5, 2024

Related U.S. Application Data
(60) Provisional application No. 63/483,138, filed on Feb. 3, 2023.

(51) Int. Cl. B64G 1/40; B64G 1/48; F17C 13/00

(52) U.S. Cl. CPC B64G 1/4021; F17C 13/008; B64G 1/48; F17C 2227/0107; F17C 2227/0304

(57) ABSTRACT

A system for fluid management in low or micro gravity environment, the system including: a two-phase gas-liquid tank suitable for storage of a two-phase gas-liquid, the two-phase gas-liquid tank including an outer surface, an inner cavity, and an outlet between the inner cavity and the outer surface. The system further includes a thermal or electromagnetic device disposed on or proximal to the two-phase gas-liquid tank. The system further includes a controller operatively coupled to the thermal or electromagnetic device, the controller being configured to energize the thermal or electromagnetic device in a controlled manner (i) to generate a thermal or electromagnetic gradient heat in the two-phase gas-liquid and (ii) urge a portion of the two-phase gas-liquid to the outlet of the two-phase gas-liquid tank.

### CROSS-REFERENCE TO RELATED APPLICATIONS

This application claims priority to U.S. Provisional Patent Application No. 63/483,138, filed Feb. 3, 2023, which is incorporated herein by reference in its entirety.

### BACKGROUND

The design of propelled small-scale satellites, for example, SmallSats or CubeSats, is driven by stringent volume constraints that force the adoption of conformal tank geometries. The irregular shape of such tanks produces corners and cavities that boost capillary interactions and drive fluid management in low-gravity environments. Phase separation, which is required in most liquid propulsion systems, is challenged by these new architectures. CubeSats have dealt with phase separation by inducing centripetal forces through spin stabilization or by making use of classical propellant management devices (PMDs).

Saturated propellants, popular due to their volumetric efficiency and self-pressurization capabilities, add another layer of complexity to the system. When the gas phase is drawn from the tank, the remaining liquid begins to vaporize until the equilibrium pressure is reached. Vaporization occurs throughout the container and further complicates the separation of phases by generating multiple small-diameter gas bubbles. Existing capillary propellant management devices (PMDs) are unable to adequately reposition multiple small-diameter bubbles, which imposes significant design challenges. For example, no space larger than the diameter of the bubble must be left in any section of the tank intended to be occupied by liquid propellant, leading to massively sized devices.

Therefore, a need exists for propellant management devices and systems for redistributing and positioning the saturated propellant.

### SUMMARY

The disclosed small satellite propellant management technologies lead to cold gas ΔV increases of up to 30% and significant power savings with respect to the state-of-the-art. By ensuring liquid-free propellant expulsion, they also facilitate the application of predictable and repeatable impulses needed in formation flying architectures. To date, this has only been achieved by high-power or low-average-thrust systems, which are not well suited to CubeSat formation flight.

Conformal propellant tank geometries are intrinsic to propelled small satellites (e.g., SmallSats and/or CubeSats) due to their stringent volume constraints. The irregular tank shape produces corners and cavities that complicate fluid management and liquid/gas separation in microgravity. In particular, the gaseous phase of saturated propellants like R-236fa cannot easily be extracted from the tank due to the nucleation and distribution of bubbles. Existing implementations address this problem by inducing a centripetal acceleration through spin stabilization, making use of a plenum that takes up to ˜30% of the tank volume, or applying heat to the thruster line, consuming up to 10 W of power. The inefficiencies of these approaches drive the need for robust propellant management technologies with greater total ΔV and reduced power consumption.

The optimization of thruster and propulsion systems for small satellite missions has been identified as a need in future spacecraft. However, managing fluids without the assistance of gravity is a driving challenge that must be overcome to achieve optimal operation. The limited volume available in SmallSats and the consequent adoption of conformal tank geometries severely complicate this task. Traditional propellant management devices (PMDs), tested for decades in axisymmetric tanks, are unable to accommodate the bubbly flows that characterize common cold gas systems, particularly when contained in irregularly shaped conformal tanks. A new generation of PMDs is needed to ensure liquid-free propellant expulsion and to support SmallSat architectures requiring accurate and predictable impulses.

The exemplary disclosure demonstrates propellant management devices that use a controlled heat flux to position a saturated liquid mixture. A first example employs capillary meshes to hold the gas phase in place once it is located near the outlet, while a second example exploits the inherent diamagnetic properties of the propellant to achieve the same goal through magnetic buoyancy.

While the primary application is the advancement of fluid management systems for SmallSat propulsion, the systems, methods, and devices of this disclosure have many crossover applications that are also relevant to fluid management under low gravity conditions. The techniques that are demonstrated here could also be used on larger satellites and higher-performance propulsion systems that require advanced fluid management. Similarly, cryogenic fluids (e.g., oxygen, hydrogen, and methane) and in-situ resource utilization systems will benefit from the same fluid management systems that are demonstrated in this disclosure. Human space flight and in-space medical devices will also benefit from miniaturized fluid management systems in orbit.

In one aspect, a system for fluid management in low or micro gravity environment (e.g., for propulsion or life support system, etc.) is disclosed, the system including: a two-phase gas-liquid tank (e.g., fuel tank, storage tank) suitable for storage of a two-phase gas-liquid (e.g., fuel, oxygen, hydrogen, methane), the two-phase gas-liquid tank including an outer surface, an inner cavity, and an outlet between the inner cavity and the outer surface. The system further includes a thermal or electromagnetic device (e.g., heater or electromagnetic field generator) disposed on or proximal to the two-phase gas-liquid tank. The system further includes a controller operatively coupled to the thermal or electromagnetic device, the controller being configured (e.g., with instructions or electric circuit) to energize the thermal or electromagnetic device in a controlled manner (i) to generate a thermal or electromagnetic gradient heat in the two-phase gas-liquid and (ii) urge a portion of the two-phase gas-liquid to the outlet of the two-phase gas-liquid tank.

In some implementations, the thermal or electromagnetic device is a thermal device (e.g., heater) disposed proximal to the outlet. The controller is configured to cause the thermal device to vaporize a portion of the two-phase gas-liquid near to the outlet of the two-phase gas-liquid tank to generate a vapor output of the two-phase gas-liquid at a pre-defined rate. In some implementations, the pre-defined rate corresponds to a controlled mass flow rate of the vapor output as a propellant for a propulsion system.

In some implementations, the thermal or electromagnetic device is a thermal device (e.g., heater) disposed distal from the outlet. The controller is configured to cause the thermal device to vaporize a portion of the two-phase gas-liquid far from the outlet of the two-phase gas-liquid tank to generate a liquid output of the two-phase gas-liquid at a pre-defined rate.

In some implementations, the two-phase gas-liquid tank asymmetrically has two or more elongated portions each having a center axis that is non-parallel to one another.

In some implementations, the system further includes a plurality of capillary panels disposed in the inner cavity extending from the outlet to an opposite side of the inner cavity, each of the plurality of capillary panels having a curvature at a top face to define a small gap adjacent to the outlet. A vapor bubble formed of the two-phase gas-liquid is urged towards or maintained within the small gap.

In some implementations, the thermal or electromagnetic device includes one or more resistive heating elements arranged in a pattern to produce a thermal gradient across the inner cavity. In some implementations, the thermal or electromagnetic device is positioned within the two-phase gas-liquid tank. In some implementations, the thermal or electromagnetic device is fixably attached to the outer surface of the two-phase gas-liquid tank proximal to the outlet.

In some implementations, the thermal or electromagnetic device includes a heat exchanger operatively coupled to an exhaust duct or pipe (e.g., to repurpose waste heat) for propellant vaporization.

In some implementations, the two-phase gas-liquid tank includes a set of pocket protrusions in the inner cavity, the set of pocket protrusions including a heater element.

In some implementations, the thermal or electromagnetic device includes a dielectrophoresis (DEP) subsystem having at least one electrode positioned in the inner cavity and configured to impart a dielectric buoyancy force on the two-phase gas-liquid inside the fuel tank which results in phase separation such that (i) a vapor output is urged towards the outlet and a liquid is directed away from the outlet, or (ii) the liquid output is urged towards the outlet and the vapor is directed away from the outlet. A first phase of the two-phase gas-liquid has a first dielectric property, and a second phase of the two-phase gas-liquid has a second dielectric property, the first and the second dielectric properties being different from one another.

In some implementations, the system further includes one or more magnets (e.g., neodymium, permanent magnet, electromagnet, etc. arranged in an array) (e.g., of a magnetic positive positioning (MPP) system) positioned proximal to the outlet, the one or more permanent magnets configured to impart a magnetic or electromagnetic buoyancy force on the two-phase gas-liquid to cause directional phase separation by urging one of a vapor or a paramagnetic or diamagnetic liquid of the two-phase gas-liquid towards the outlet and the other of the vapor or the paramagnetic liquid of the two-phase gas-liquid away from the outlet.

In some implementations, the system further includes one or more storage tanks coupled to an output of the two-phase gas-liquid tank, wherein the one or more storage tanks feed a propulsion system or a life support system. In some implementations, the system is configured for integration with a small satellite propulsion system. The two-phase gas-liquid tank includes an asymmetric volume, and the two-phase gas-liquid includes a propellant. In some implementations, the system is configured for integration with a life support system.

In some implementations, the controller is configured to adjust the energization of the thermal or electromagnetic device, wherein energization of the thermal device is configured to increase the generation of a vapor output as the volume of the two-phase gas-liquid decreases. In some implementations, the controller is configured to (i) determine a required vapor output rate and (ii) determine a required ullage in the two-phase gas-liquid tank for the required vapor output rate by calculating a rate of vapor output generation and disposition to the outlet.

In some implementations, the two-phase gas-liquid tank and outlet have an inertia-induced separation configuration, including the outlet being disposed along a vehicle direction of travel to apply inertia force to the two-phase gas-liquid opposite to the vehicle direction of travel and urge a vapor output towards the outlet. In some implementations, the two-phase gas-liquid includes ferromagnetic particles.

In another aspect, a non-transitory computer-readable medium is disclosed having instructions stored thereon for the execution of a controller for a fluid management system in a low or micro gravity environment. The fluid management system includes a two-phase gas-liquid tank (e.g., fuel tank, storage tank) suitable for storage of a two-phase gas-liquid (e.g., fuel, oxygen), the two-phase gas-liquid tank including an outer surface, an inner cavity, and an outlet between the inner cavity and the outer surface. A thermal or electromagnetic device (e.g., heater or electromagnetic field generator) is disposed proximal to the two-phase gas-liquid tank. A controller is operatively coupled to the thermal or electromagnetic device, the controller is configured (e.g., with instructions or electric circuit) to energize the thermal or electromagnetic device in a controlled manner (i) to generate a thermal or electromagnetic gradient heat in the two-phase gas-liquid and (ii) vaporize, via the thermal device, a portion of the two-phase gas-liquid near the outlet of the two-phase gas-liquid tank to generate a vapor output of the two-phase gas-liquid at a pre-defined rate. Execution of the instructions by a processor causes the processor to: determine a required vapor output rate and determine a required ullage in the two-phase gas-liquid tank for the required vapor output rate by calculating a rate of vapor output generation and disposition to outlet.

In another aspect, a system for fluid management in low or micro gravity environment (e.g., for propulsion or life support system, etc.) is disclosed, the system including a two-phase gas-liquid tank (e.g., fuel tank, storage tank) suitable for storage of a two-phase gas-liquid (e.g., fuel, oxygen, hydrogen, methane). The two-phase gas-liquid tank includes an outer surface, an inner cavity, and an outlet between the inner cavity and the outer surface. The system further includes one or more permanent magnets (e.g., neodymium) (e.g., of a magnetic positive positioning (MPP) system) positioned proximal to the outlet. The permanent magnet is configured to impart a magnetic or electromagnetic buoyancy force on the two-phase gas-liquid to cause directional phase separation such that one of a vapor or a liquid of the two-phase gas-liquid is urged towards the outlet and the other of the vapor or the liquid of the two-phase gas-liquid is directed away from the outlet.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

FIG. 1A shows an example system for propellant management having a thermal device and a capillary structure, according to one implementation.

FIG. 1B shows a perspective view of the system of FIG. 1A.

FIG. 1C shows a perspective view of an example system for propellant management having a capillary structure, according to one implementation.

FIG. 2A shows an example system for propellant management having a magnet, according to one implementation.

FIG. 2B shows an example system for propellant management having a magnet and a thermal device, according to one implementation.

FIG. 2C shows a perspective view of the system of FIG. 2B.

FIG. 2D shows a graph of simulation results showing the relative acceleration imparted on a fluid by a magnet.

FIG. 2E depicts an example Halbach array of magnets, each having a minimum spacing of 1 mm, with a larger 2 mm spacing between each quadrant of the array, according to one implementation.

FIG. 2F shows a graph of simulation results showing the relative acceleration imparted on a fluid by the Halbach array of FIG. 2E.

FIG. 3A shows an example system for propellant management having a dielectrophoretic structure, according to one implementation.

FIG. 3B shows a perspective view of the system of FIG. 3A.

FIG. 3C shows an example system for propellant management including a dielectrophoretic structure and a thermal device, according to one implementation.

FIG. 3D displays analytical results of a dielectrophoretic structure acting upon a fluid.

FIG. 4 shows an example propellant management system that includes a thermal device, a magnet, and a dielectrophoretic structure, according to one implementation.

FIGS. 5A-5D show alternative geometries and configurations of a propellant tank having asymmetrical geometries.

FIG. 5E shows a wedge-shaped propellant tank with analytic results of a dielectrophoretic structure acting upon a fluid therein, according to one implementation.

FIGS. 6A-6C show a ground demonstration unit built for testing a propellant management system, according to one implementation.

FIG. 7A shows an example CubeSat having an integrated propellant management system of this disclosure.

FIG. 7B shows an example of a propellant tank having a plenum splitting the liquid and vapor portions.

FIG. 8A shows the results of a simulated vapor bubble geometry in microgravity without propellant management at various fill fractions.

FIG. 8B shows the results of a simulated vapor bubble geometry during acceleration without propellant management at various fill fractions.

FIG. 8C shows a graph of the maximum stored propellant mass as a function of the expected operating temperature range of the propulsion system.

FIG. 8D shows a graph of the minimum required ullage volume as a function of the expected operating temperature range of the propulsion system.

FIG. 8E shows a graph of maximum sustainable adverse acceleration on a vapor bubble in direct contact with a Halbach array, according to one implementation.

FIG. 8F shows a graph of the vertical acceleration experienced by a vapor bubble with height measured as the distance between the Halbach array and the base of the bubble, according to one implementation.

FIG. 9A shows a series of images over time depicting a prototypical propellant tank of the present disclosure used for testing.

FIG. 9B shows another series of images over time depicting a prototypical propellant tank used for testing procedures.

FIG. 9C shows a graph depicting the preliminary effects of power input over time on the bubble shrink rate.

FIG. 9D shows a series of images over time depicting microgravity tests.

FIG. 10 shows an example controller or an example computing device, according to one implementation. Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

### DETAILED DESCRIPTION

Referring generally to the figures, propellant management systems and devices for low or microgravity operation are shown, according to various implementations.

Generally, propellant management devices (PMDs) are designed to keep a propellant vapor bubble over the outlet of the tank during a variety of operating regimes (e.g., during acceleration or during constant velocity operation). For a saturated, or two-phase, propellant, maintaining the gas phase in a desired location can be particularly challenging due to the tank geometries involved. This disclosure describes a variety of propellant management systems, methods, and devices for differently sized and shaped propellant tanks. For several examples, the propellant tank is a “3 U” propellant tank formed from three 10 cm cubed units of a standard CubeSat structure. The propellant used may be R-236fa or any other standard saturated propellant.

The proposed PMDs include two main components: a heater and a gas retention device which adopts the form of a capillary mesh, a magnet array, or a dielectrophoretic structure. The devices, systems, and methods disclosed herein demonstrate promising (i) capillary (ii) magnetic, (iii) dielectrophoretic, and (iv) combination propellant management devices (PMDs) to reposition saturated mixtures in SmallSat propellant tanks. A heat patch or thermal device may be used in each PMD to vaporize the liquid near (or away from) the outlet, creating a vapor bubble in a desired location. Once the vapor bubble is generated, other technologies of this disclosure maintain the vapor bubble in a desired location (e.g., over an outlet of a fuel tank). In some implementations, the vapor bubble is maintained in the desired location via capillary forces (e.g., by means of a screen mesh of a capillary device). In other implementations, the vapor bubble is maintained in the desired location via a local acceleration or buoyancy force on the bubble (e.g., a magnet array or dielectrophoretic structure to impose a local acceleration field).

### Example System #1— Capillary Structure

In propellant tanks having an asymmetrical structure, as is common in CubeSats, the position of the liquid or vapor of the two-phase saturated propellant mixture is affected by capillary forces within the propellant tank. Distributed vapor bubbles arise from phase change processes and sharp-edged conformal geometries. The vapor bubble distribution is also caused by propellant vaporization along the walls as the thruster actuates. Vaporization and condensation of propellant on hot and cold walls, respectively, further contribute to this distribution. Each of these phenomena results in many small vapor bubbles being generated throughout the propellant volume. These bubbles are not easily positioned by capillary forces due to their small diameter. The conformal tank geometry undermines the positioning of the vapor bubble because surface tension drives liquids to the corners of the propellant tank. It becomes challenging to ensure that the liquid phase does not migrate from these corners to the propellant outlet at high fill fractions.

Because R-236fa is stored as a two-phase fluid, it vaporizes in the higher temperature section near the heater and condenses in lower temperature regions of the propellant tank. This effect can be exploited to reorient the propellant within the tank. It can also localize the majority of vaporization during thruster operation to the area near the heater, hence reducing the time of flight of the bubbles toward the interface.

In standard propellant tanks, a small thermal gradient alone cannot orient the propellant at a high fill fraction. The movement caused by vaporization disturbs the equilibrium interface, with capillary forces inducing a convective flow that drives the propellant along the walls. This issue can be remedied by implementing a capillary PMD in combination with the thermal gradient, with the former acting as an anchor for the liquid phase that, in addition, reduces fluid circulation within the tank. In this case, the capillary PMD is not required to drive gas toward the propellant outlet: it simply has to retain the liquid propellant in place.

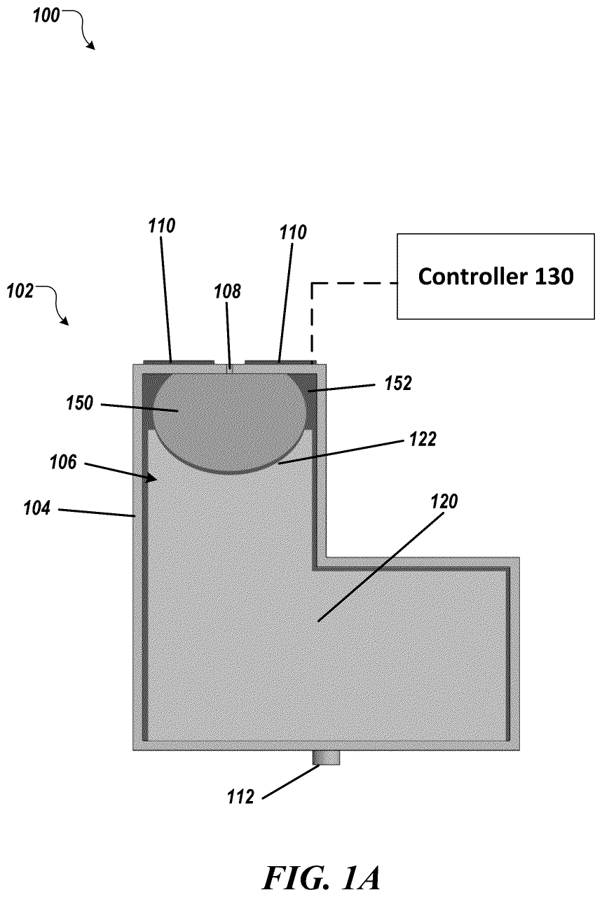

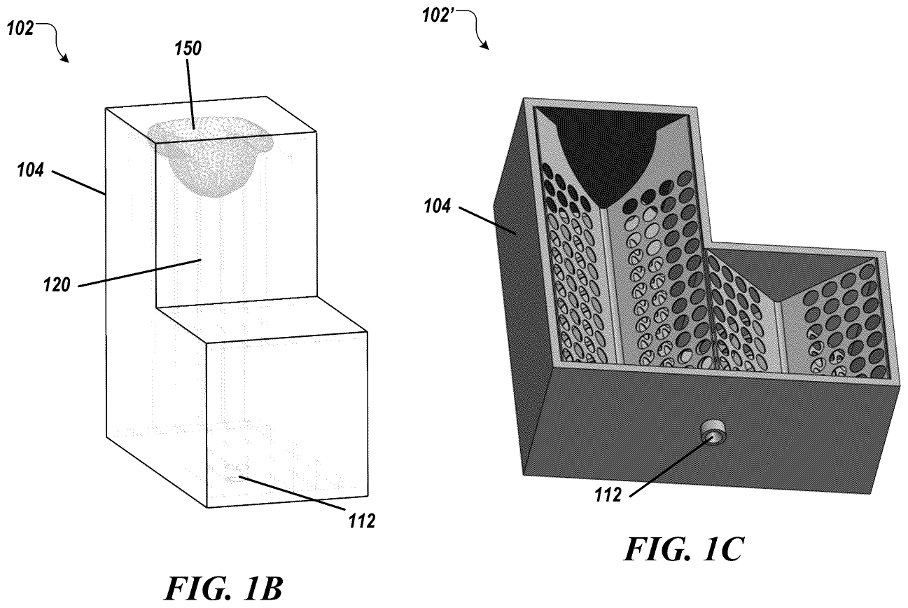

FIGS. 1A-1B show an example system 100 for propellant management having a thermal device 110 and a capillary structure 120 that addresses the current problems of liquid-vapor positioning. The system 100 includes a two-phase gas-liquid tank 102 suitable for storage of a two-phase gas-liquid propellant (e.g., R-236fa). The tank 102 includes an outer surface 104, an inner cavity 106, and an outlet 108 between the inner cavity 106 and the outer surface 104. The tank 102 also defines a fuel inlet 112 on an end opposite of the outlet 108.

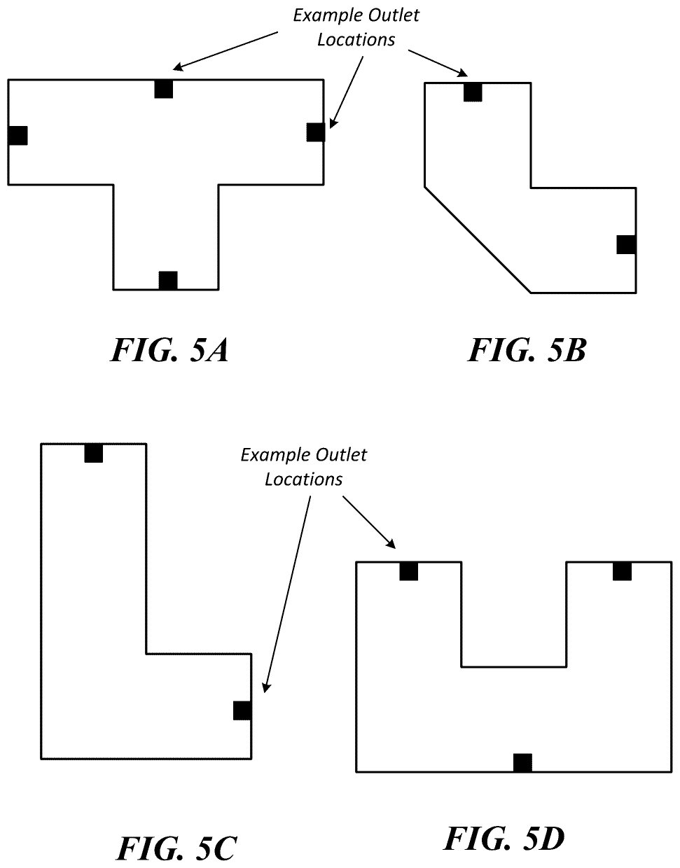

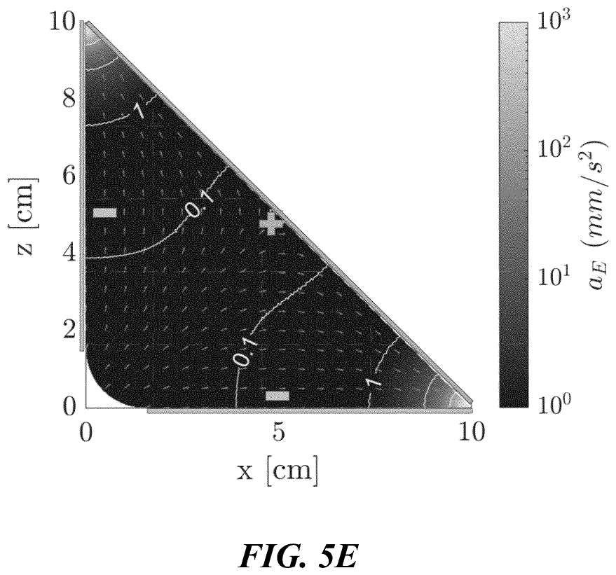

The tank 102 tank is an L-shaped tank 102 composed of three standard 10 cm³ units of a CubeSat (a “3 U” tank). However, in other implementations, the tank has a variety of asymmetrical geometries having two or more elongated portions each having a center axis that are non-parallel to one another (e.g., see the alternative geometries shown in FIGS. 5A-5E). In some implementations, the systems, methods, and devices of this disclosure may also be implemented into symmetric tanks.

The thermal device 110 is disposed on the outer surface 104 of the tank 102 adjacent to the outlet 108. The thermal device 110 includes two heaters (e.g., resistive heaters) configured to produce a thermal gradient across the inner cavity 106 of the tank 102 and to heat the liquid-vapor propellant adjacent to the outlet 108. In other implementations, the thermal device is disposed within the inner cavity of the tank. In other implementations, a plurality of thermal devices is disposed within the tank at various locations from end to end to create a thermal gradient. In other implementations, the thermal device is positioned away from the outlet (e.g., when a liquid output is desired).

The capillary structure 120 of the system 100 is disposed in the inner cavity 106 of the tank 102. The capillary structure 120 includes one or more thin fin members extending substantially from one end of the inner cavity 106 to the other. The capillary structure 120 defines a gap 122 formed by the curvature of the one or more thin fin members. The gap 122 is defined near the outlet 108 and configured to maintain a vapor bubble 150 at the outlet 108. The liquid portion 152 of the two-phase propellant occupies the remaining space of the inner cavity 106 outside of the gap 122.

As shown in FIGS. 1A and 1B, the system 100 includes six thin fin members or flat capillary panels extending from an end of the tank 102 having the fuel inlet 112 towards the end of the tank 102 having the outlet 108 (and the gap 122 defined thereat). The capillary structure 120 of FIGS. 1A and 1B occupies a volume of 86 cm³ and, if made of aluminum, has a mass of approximately 232 grams. The mass and volume budgets could be optimized further, but the design shown here is representative of a traditional capillary PMD. In other implementations, the capillary structure could have a different geometry, a different volume, a different weight, or comprise a different material. For example, as shown in FIG. 1C, the tank 102′ has a capillary structure including diagonally arranged capillary panels, each panel defining an array of holes.

The system 100 further includes a controller 130 in operatively coupled to and in electrical communication with the thermal device 110. The controller 130 is configured with instructions, or an electric circuit, to energize the thermal device 110 in a controlled manner to generate a thermal gradient heat in the two-phase gas-liquid propellant. The generated thermal gradient optionally generates the vapor bubble 150 and/or urges other vapor portions of the two-phase propellent to merge with the vapor bubble 150. The generated thermal gradient then urges a portion (e.g., the vapor bubble 150) of the propellant to the outlet 108 of the tank 102. The capillary structure 120 aids in this positioning by maintaining the liquid portion 152 of the propellant engaged with the thin fin members via capillary action which the vapor portions can move to the gap 122 adjacent to the outlet 108. In other words, the two-phase propellant reaches a minimum energy configuration when the vapor bubble 150 is positioned in the gap 122 over the outlet 108.

The controller 130 can also cause the thermal device 110 to generate a vapor output of the two-phase gas-liquid propellant at a pre-defined rate. The pre-defined rate may correspond, for example, to a controlled mass flow rate of the vapor outlet as a propellant for a propulsion system. For example, a thruster operation for the CubeSat may initiate the controller 130 to cause the thermal device 110 to generate a predefined vapor output corresponding to the mass flow rate of propellant required to burn during the thruster operation.

### Example System #2— Magnetic Structure

Magnetic positive positioning (MPP) uses magnetic fields to attract or repel fluids. The differential force applied to the liquid and gas phases of the fluid leads to a magnetic buoyancy effect that results in phase separation. This buoyancy effect is the result of the liquid and gaseous phases of the propellant having different magnetic susceptibilities and, therefore, experiencing differing forces. MPP devices have recently seen an increase with the availability of high-density neodymium magnets and the increasing popularity of small-scale propulsion systems.

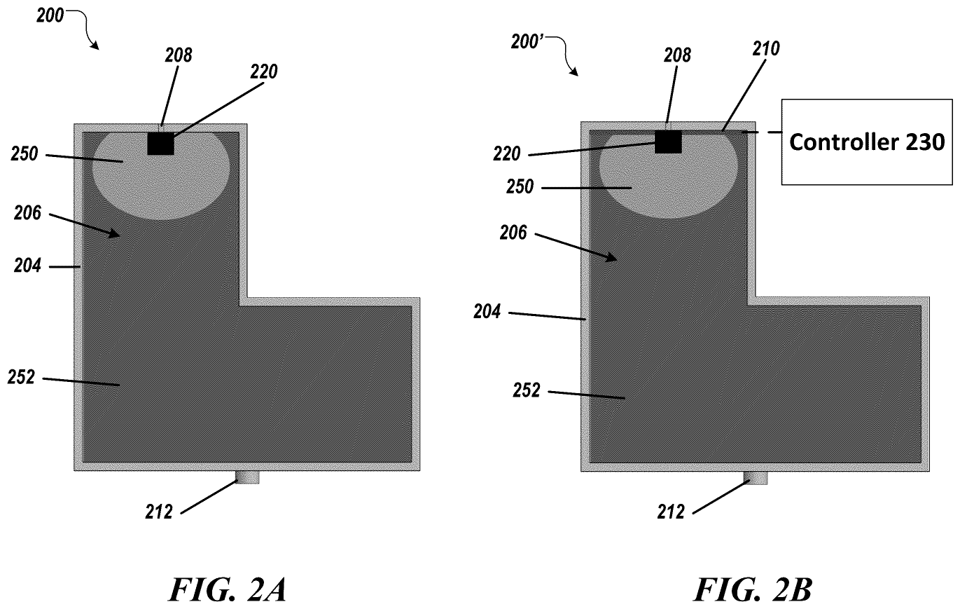

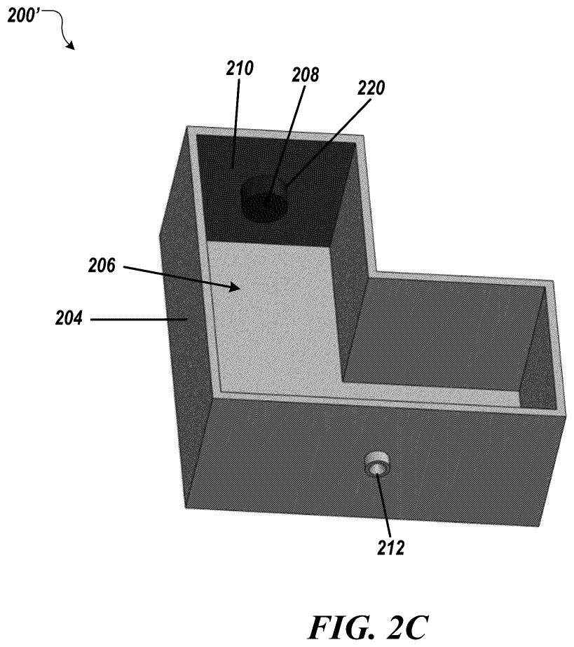

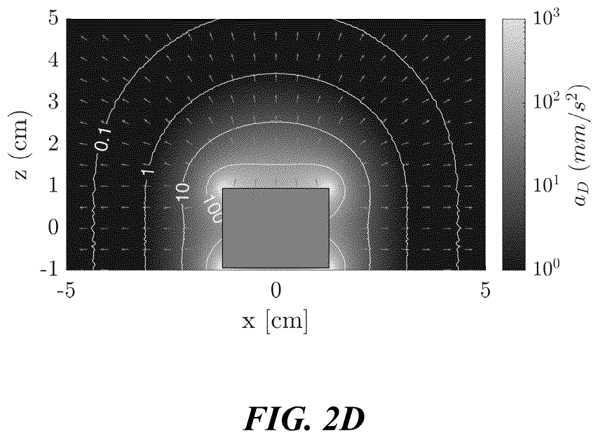

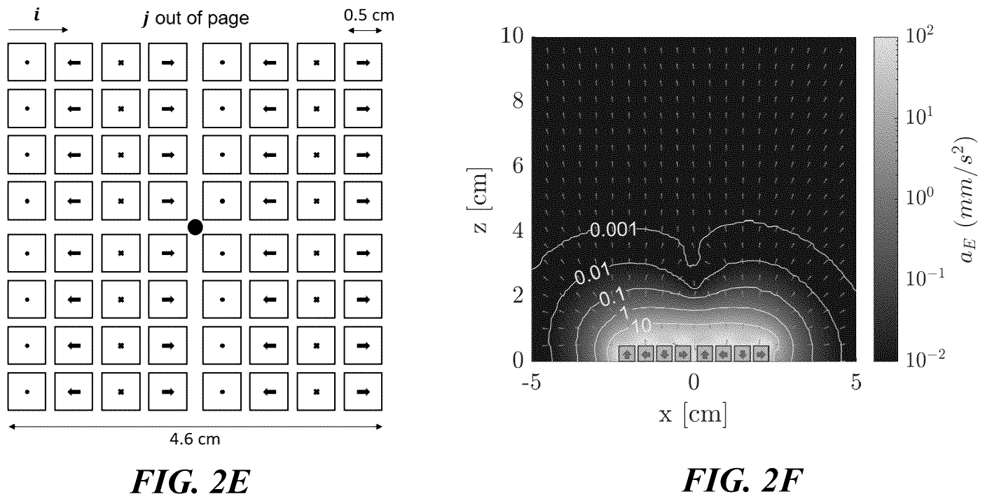

FIG. 2A shows an example system 200 for propellant management having a magnet 220. The system 200 includes a two-phase gas-liquid tank 202 suitable for storage of a two-phase gas-liquid propellant (e.g., R-236fa). The tank 202 includes an outer surface 204, an inner cavity 206, and an outlet 208 between the inner cavity 206 and the outer surface 204. The tank 202 also defines a fuel inlet 212 on an end opposite of the outlet 208.

The magnet 220 is positioned proximal to the outlet 220. The magnet 220 is configured to impart a magnetic buoyancy force on the two-phase gas-liquid propellant to cause directional phase separation. The magnetic buoyancy force urges the vapor bubble 250 towards the outlet 208 while the remaining liquid portion 252 of the propellant is positioned away from the outlet 208. In other implementations, the liquid portion may be urged towards the outlet, and the vapor bubble may be pulled away from the outlet.

The magnet 220 of FIG. 2A is a single, cylindrical, permanent neodymium magnet. However, in other implementations, one or more magnets (e.g., an array of magnets) may be utilized in the propellant management system. In other implementations, the magnet is another type of permanent magnet. In other implementations, the magnet may be an electromagnet controllable via a controller of the system.

In some implementations, the two-phase liquid-vapor propellant may be a ferromagnetic propellant or a diamagnetic propellant to improve the overall system performance and phase separation. This can be accomplished through the suspension of ferromagnetic particles within the fluid propellant. The forces on such a propellant are significantly greater than those imparted on a diamagnetic or paramagnetic fluid. A system architecture based on the use of a ferromagnetic propellant involves placing permanent magnets within the tank, opposite the outlet. The liquid is then attracted to these magnets, leaving the vapor bubble positioned over the tank outlet.

The magnetic positive positioning (MPP) system 200 may be augmented by the addition of a resistive heater (e.g., the thermal device 110 of FIGS. 1A-1B). FIGS. 2B and 2C show an example system 200′ for propellant management having a thermal device 210 and a magnet 220. The system 200′ is substantially similar to the system 200 of FIG. 2A, except as described below.

The thermal device 210 is disposed within the inner cavity 206 adjacent to the outlet 208 of the tank 202. The thermal device 210 is a resistive heater configured to produce a thermal gradient across the inner cavity 206 of the tank 202 and to heat the liquid-vapor propellant adjacent to the outlet 208. In other implementations, the thermal device is disposed outside the inner cavity of the tank. In other implementations, a plurality of thermal devices is disposed within the tank at various locations from end to end to create a thermal gradient. In other implementations, the thermal device is positioned away from the outlet (e.g., when a liquid output is desired).

The system 200′ further includes a controller 230 operatively coupled to and in electrical communication with the thermal device 210. The controller 230 and the thermal device 210 operate substantially similarly to the controller 130 and thermal device 110 of system 100. That is, the controller 230 is configured with instructions, or an electric circuit, to energize the thermal device 210 in a controlled manner to generate a thermal gradient heat in the two-phase gas-liquid propellant. The generated thermal gradient optionally generates the vapor bubble 250 and/or urges other vapor portions of the two-phase propellent to merge with the vapor bubble 250. The generated thermal gradient then urges a portion (e.g., the vapor bubble 250) of the propellant to the outlet 208 of the tank 202. The magnet 220 aids in this positioning by creating a magnetic buoyancy force in the inner cavity 206 to maintain the vapor bubble 250 adjacent to the outlet 208.

By imposing a thermal gradient, a more robust propellant management system is created by ensuring propellant reorientation through vaporization and condensation. The MPP device is then responsible for maintaining the vapor bubble over the tank outlet during operations. This solution mitigates issues associated with the rapid decrease in magnetic field intensity as distance from the source increases. It also reduces the risk of expelling liquid droplets formed during the vaporization of the propellant.

Magnetic Testing and Arrangements. An analysis was performed to visualize the acceleration of the liquid propellant influenced by an N52 neodymium magnet concentric with the propellant outlet. The magnet under consideration has a diameter of 25.4 mm, a height of 19.05 mm, and a mass of 72.4 grams. The simulation results are shown in FIG. 2D. The magnet induces accelerations of over 10 cm/s² within 5 mm of its surface, but the acceleration decreases rapidly to less than 1 mm/s² at just over 2.5 cm away. These large local accelerations are ideal for repelling liquid droplets from the outlet of the tank.

In some implementations, a Halbach array may be considered in place of a single magnet. For example, a single cylindrical magnet in a system on a spacecraft may experience a torque from the Earth's magnetic field at altitude, affecting performance. Halbach arrays are tessellar magnetic structures whose magnetization vector is oriented following a sinusoidal pattern. A primary consequence of this arrangement is the reinforcement of the magnetic polarization force module on one side and its cancellation on the other. The array can be configured to experience no net torque due to external magnetic fields by compensating the dipoles from every individual magnet, making it better suited for use on a small satellite.

A configuration composed of an 8×8 grid (or array) of 4.76 mm cubic N52 neodymium magnets was evaluated. The array has a total volume of 6.9 cm³ and a mass of approximately 52 g. The magnets, depicted in FIG. 2E, have a minimum spacing of 1 mm, with a larger 2 mm spacing between each quadrant of the array to allow room for the propellant exit. The magnetic field generated by this configuration allows for a strong field directed into the propellant tank and a weaker field directed out of the tank. This configuration was analyzed to assess the force it applies to a vapor bubble and the strength of the magnetic field generated. The analysis utilizes a 1 m³ bounding box with a magnetic insulation boundary condition to capture the decay of the magnetic field. The acceleration of the liquid due to the Halbach array is shown in FIG. 2F. Accelerations greater than 10 mm/s² are experienced near the array, though these values rapidly decay. The contours of acceleration indicate a decreased value over the center of the array. This is a result of the larger spacing between the central magnets to accommodate the propellant outlet. The Halbach array provides a less powerful acceleration field than a single magnet, but its benefits in limiting the magnetic field directed out of the tank and not applying a net torque to the spacecraft make it more suitable for certain implementations.

### Example System #3— Dielectrophoretic Structure

The term dielectrophoresis (DEP) refers to the electric polarization of dielectric fluids when exposed to electric field gradients. The force exerted on the fluid is proportional to its permittivity. For two-phase liquid-vapor propellants of this disclosure, the permittivities of the gas and liquid phases are different, and therefore a dielectric buoyancy effect is produced. Because the permittivity of a gas bubble is orders of magnitude smaller than that of the dielectric liquid, the gas bubble map be repelled from areas of high electric field magnitude.

DEP can be thought of as analogous to MPP, with the equations for their driving forces sharing nearly identical forms. While the use of DEP in propellant management in large volumes requires high potential differences to increase the range of the DEP force, the relatively smaller-sized CubeSat propellant tanks require lower voltages to generate large electric field gradients. Therefore, CubeSat propellant tanks, like those of this disclosure, are better suited to a DEP system.

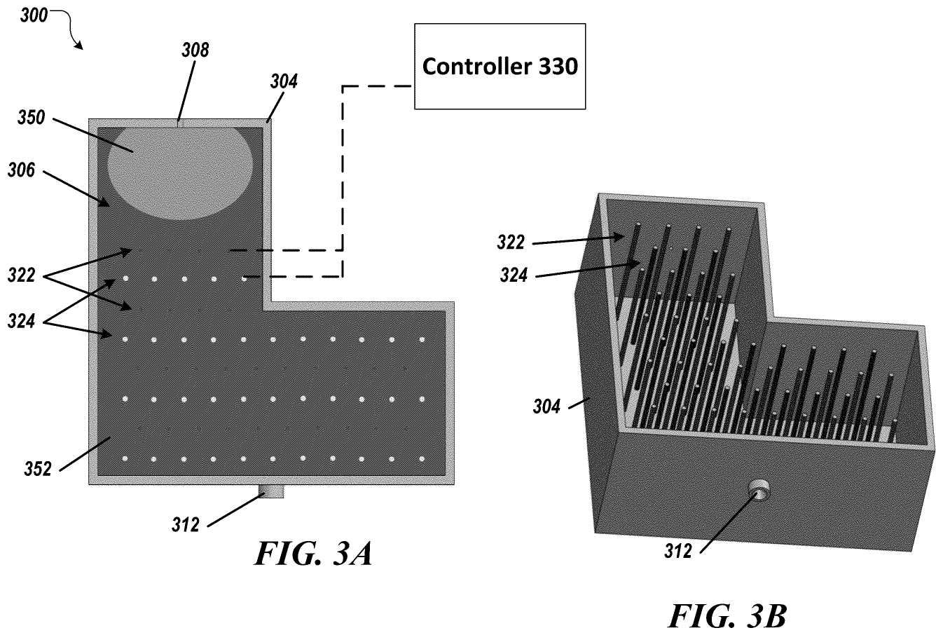

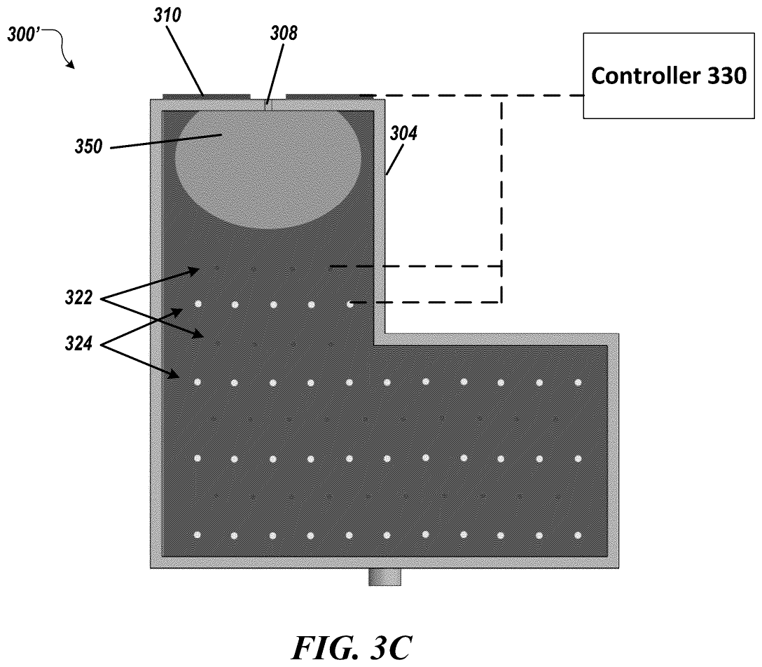

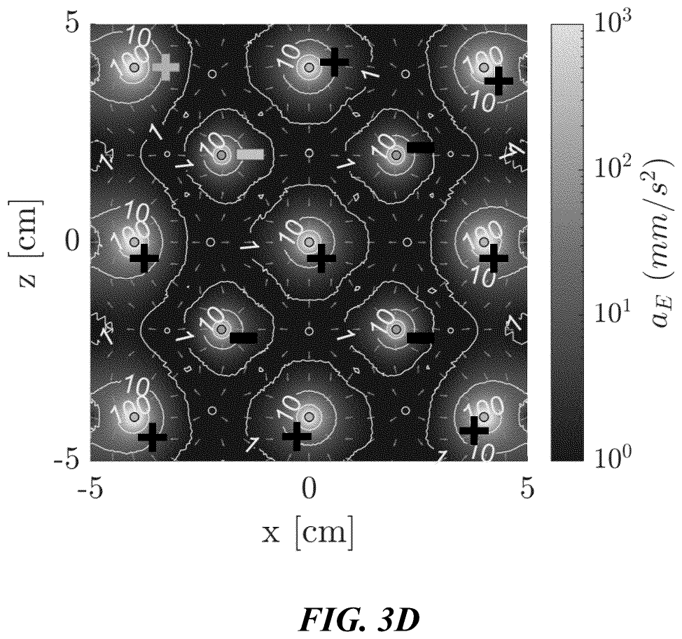

FIGS. 3A and 3B show an example system 300 for propellant management having a dielectrophoretic structure 320. The system 300 includes a two-phase gas-liquid tank 302 suitable for storage of a two-phase gas-liquid propellant (e.g., R-236fa). The tank 302 includes an outer surface 304, an inner cavity 306, and an outlet 308 between the inner cavity 306 and the outer surface 304. The tank 302 also defines a fuel inlet 312 on an end opposite of the outlet 308.

The tank 302 tank is an L-shaped tank 302 composed of three standard 10 cm³ units of a CubeSat (a “3 U” tank). However, in other implementations, the tank has a variety of asymmetrical geometries having two or more elongated portions each having a center axis that is non-parallel to one another (e.g., see the alternative geometries shown in FIGS. 5A-5E).

The dielectrophoretic structure 320 includes a series of wires strung across the inner cavity 306 of the two-phase gas-liquid tank 302, the wires being positioned away from the outlet 308. As shown, the series of wires includes alternative rows of wires including positive wires 322 and negative wires 324 alternating across the dielectrophoretic structure 320. The wires alternate high and low potential (e.g., positive wires 322 and negative wires 324), creating areas of high electric field intensity to attract the liquid portion 352 of the propellant. By appropriately positioning the wires, this approach can be used to prevent liquid from exiting the propellant tank 302.

The system 300 further includes a controller 330 operatively coupled to and in electrical communication with the dielectrophoretic structure 320. The controller 330 is configured with instructions, or an electric circuit, to energize the dielectrophoretic structure 320 in a controlled manner to generate an electric field gradient in the two-phase gas-liquid propellant. The generated electric field gradient attracts the liquid portion 352 of the two-phase propellant, urging the vapor bubble 350 towards the outlet 308.

Similar to the capillary structure, the DEP system can hold the liquid-vapor propellant in place, but it cannot generate a liquid or a vapor portion of the propellant. However, a thermal device may be implemented with the DEP structure, similar to the capillary and MPP structures. FIG. 3C shows an example implementation of a system 300′ including a thermal device 310 disposed adjacent to the outlet 308. The thermal device 310, and the controller 330 coupled thereto, operate in a manner similar to the above-described thermal devices (e.g., thermal device 110 of system 100 and thermal device 210 of system 200).

The DEP system 300′ with the addition of a heater, is expected to perform well at both the initial reorientation of the propellant and positioning of the propellant vapor bubble during operation. The body force imparted on the fluid attracts any small droplets of liquid that may be created during the initial phase change and reorientation of the propellant. Unlike the magnetic positive positioning propellant management device (MPP PMD), which actively repels liquid from the outlet of the tank, this system 300′ serves to attract the liquid to an area away from the outlet. This difference is subtle but it has direct impacts on performance. While the force from the MPP DEP grows stronger as the liquid approaches the outlet, the DEP force decreases.

A unique benefit of the DEP PMD is that it can be designed to increase the rate at which vapor bubbles detach and rise to the top of the tank during thruster operation. By generating a gradient in electric field strength near the walls of the tank, a dielectrophoretic force can be used to attract liquid propellant and effectively repel bubbles from the wall as they form. This decreases the required ullage volume for nominal operations.

Dielectrophoresis Testing and Arrangements. An analysis was performed on a model DEP system to simulate the acceleration of liquid R-236fa with 1 kV potential. The results of the analysis are shown in FIG. 3D, wherein positively charged wires are denoted with a (+) symbol and grounded wires are denoted with a (−) symbol. Liquid in proximity to the wires experiences accelerations of up to 0.1 m/s² radially inward. By positioning wires in the simulated configuration within a propellant tank, the liquid can be held away from the outlet and resist disturbances. This method can be used to ensure only vapor escapes from the tank. Additionally, the positioning of the wires, as well as their potential, can be adjusted to generate a variety of electric field configurations. There is also the possibility of actively changing the potential in individual wires during operation to adjust the propellant position. This could be used to actively change the center of mass of the spacecraft and thereby vary the angular momentum imparted during maneuvers.

### Example System #4— Integrated System

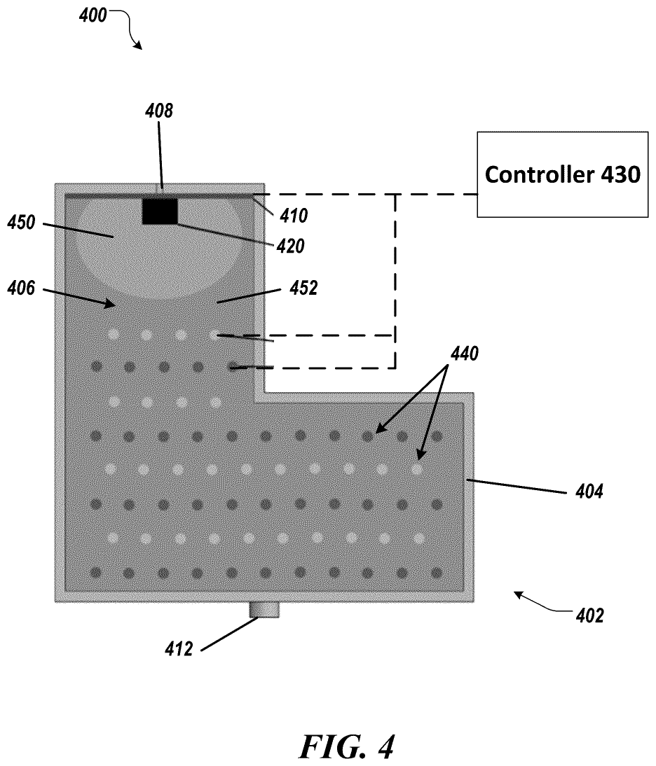

FIG. 4 shows an example propellant management system 400 that includes several of the previously described devices, systems, and methods in a single system 400. The system 400 includes a tank 402, similar to the above-described examples. The tank 402 includes an outer surface 404, an inner cavity 406, and an outlet 408 between the inner cavity 406 and the outer surface 404. The tank 402 also defines a fuel inlet 412 on an end opposite of the outlet 408.

The system 400 includes a thermal device 410 disposed within the inner cavity 406 adjacent to the 408. The thermal device 410 operates similarly to the thermal device 110 of system 100. The system 400 further includes a magnet 420 positioned adjacent to the outlet 408. The magnet 420 operates similarly to the magnet 220 of the system 200. The system 400 further includes a dielectrophoretic structure 440 positioned within the inner cavity 406 of the tank 402. The dielectrophoretic structure 440 operates similarly to the dielectrophoretic structure 320 of the system 300. The system 400 further includes a controller 430 in communication with each of the thermal device 410 and the dielectrophoretic structure 440. The controller 430 operates similarly to the controllers of previous examples (e.g., any one of the controller 130 of system 100, the controller 230 of system 200, or the controller 330 of the system 300).

Together, each of the subsystems or devices of the system 400 form a propellant management system 400 configured to create and maintain a vapor bubble 350 of propellant adjacent to the outlet 408. For example, the thermal device 410 is configured to create a thermal gradient throughout the inner cavity 406 of the 402 and to vaporize a portion of the two-phase liquid-vapor propellant. The magnet 420 is configured to create a magnetic buoyancy force within the inner cavity 406 of the tank 402, urging the vapor bubble 450 towards the outlet 408 and urging the liquid portion 452 away from the outlet 408. The dielectrophoretic structure 440 is configured to create an electric potential gradient within the inner cavity 406 of the tank 402 to retain the liquid portion 452 away from the outlet 408. Finally, the controller 430 is configured to operate each of the thermal device 410 and the dielectrophoretic structure 440 (including the positively and negatively charged wires therein).

### Example Tank Shapes

The propellant tanks of this disclosure can define a variety of geometries. While the shapes shown in the above-described examples are primarily L-shaped tanks, other shapes are contemplated by this disclosure.

For example, FIG. 5A shows a T-shaped propellant tank having several marked locations where an example outlet could be located. The T-shaped tank of FIG. 5A occupies a 4 U space (i.e., four standardized 10 cm³ units of a CubeSat). However, in other implementations, the T-shaped tank may take up more or less volume.

FIG. 5B shows an L-shaped propellant tank having a chamfered corner. The chamfered-L-shaped tank includes several marked locations, for example, outlets. The chamfered-L-shaped tank occupies a 2.5 U space; however, in other implementations, the chamfered-L-shaped tank may take up more or less volume.

FIG. 5C shows an L-shaped propellant tank having one portion longer than the other portion, or a “long-L-shape.” The long-L-shaped tank includes several marked locations for example outlets. The long-L-shaped tank occupies a 4 U space; however, in other implementations, the long-L-shaped tank may take up more or less volume.

FIG. 5D shows a U-shaped propellant tank. The U-shaped tank includes several marked locations for example outlets. The U-shaped tank occupies a 5 U space; however, in other implementations, the U-shaped tank may take up more or less volume.

FIG. 5E shows a wedge-shaped propellant tank. In particular, FIG. 5E shows a graph of the liquid acceleration in a wedge-shaped dielectrophoresis (DEP) propellant management device with the diagonal wall held at 1 kV and all other walls grounded. A DEP system of this disclosure (e.g., the dielectrophoretic structure 320) could be successfully implemented in a wedge-shaped tank, and it would be effective in positioning both small and large vapor bubbles. A 3 U propellant tank could be segmented into four separate wedge-shaped geometries to allow for a DEP system to operate. The proof of concept of a single wedge is shown in FIG. 5E with the acceleration of the liquid propellant plotted. The liquid is attracted to the two 45° corners of the wedge and repelled from the filleted corner. A hydrophobic coating applied to the filleted corner could prevent capillary forces from collecting liquid propellant there. A tank composed of multiple wedges could also be a useful technology for a spacecraft capable of thrust in multiple directions. In that case, appropriate orientation and charging of the walls of the wedges could allow for a system capable of consistently delivering vapor to a thruster in spite of adverse accelerations.

### Experimental Results and Additional Examples

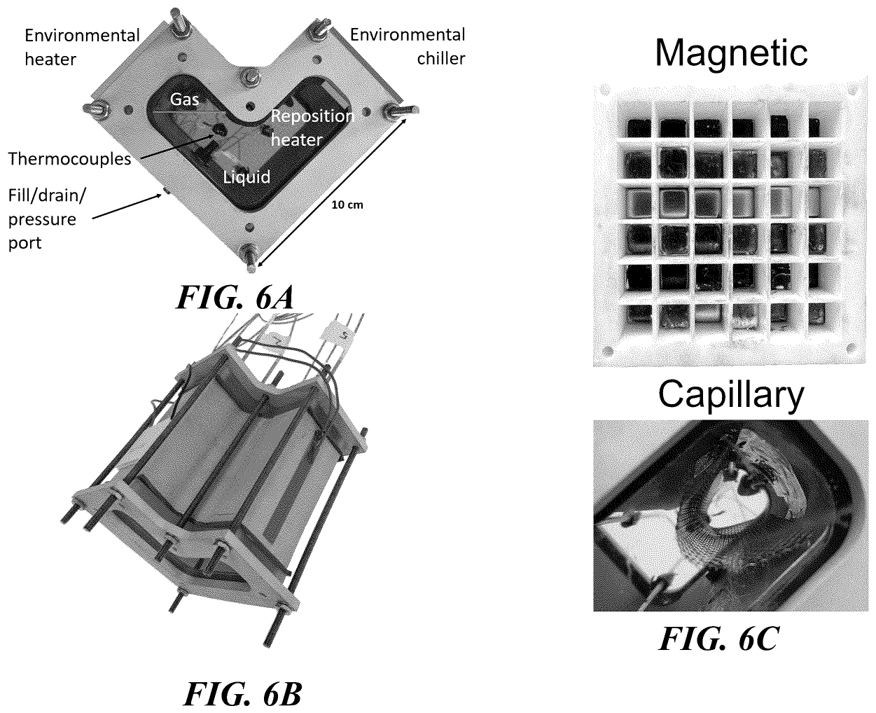

FIGS. 6A-6C show a ground demonstration unit build for testing the propellant management systems of this disclosure (e.g., in a parabolic flight test). The prototype propellant tank of FIGS. 6A-6C is 1 U (10 cm³) composed of¾U conformal propellant tank and ¼U electronics compartment (including a camera mount for data collection in-flight). FIG. 6A shows a front view of the prototype propellant tank, while FIG. 6C shows a perspective view. The prototype propellant tank includes a glass window on the front for viewing the behavior of the two-phase liquid-vapor propellant therein (shown in FIG. 6A). The tank is 3D printed from Somos PerFORM, which is regularly used in CubeSat tanks.

The prototype propellant tank of FIGS. 6A-6C is configured to demonstrate gas bubble reorientation under a range of thermal and environmental conditions. An environmental heater and an environmental cooler are coupled to the outside of the tank on opposing sides. The environmental heater and cooler are configured to replicate environmental conditions (e.g., solar irradiance or lack thereof). A plurality of thermocouples is disposed within the tank to track temperature values at various points in the tank during flight operations and testing. A reposition heater is positioned inside the tank to generate a thermal gradient to generate a vapor bubble and urge it toward the desired location.

The prototype propellant tank is augmented with a magnetic array and a capillary mesh propellant management device (shown in FIG. 6C). The magnetic array and capillary mesh retain and coalesce gas bubbles generated through vaporization. The magnetic array is formed in a Halbach array to induce a uniform polarization force on the liquid. The capillary mesh covers the outlet and forces bubble coalescence.

### Example CubeSat System

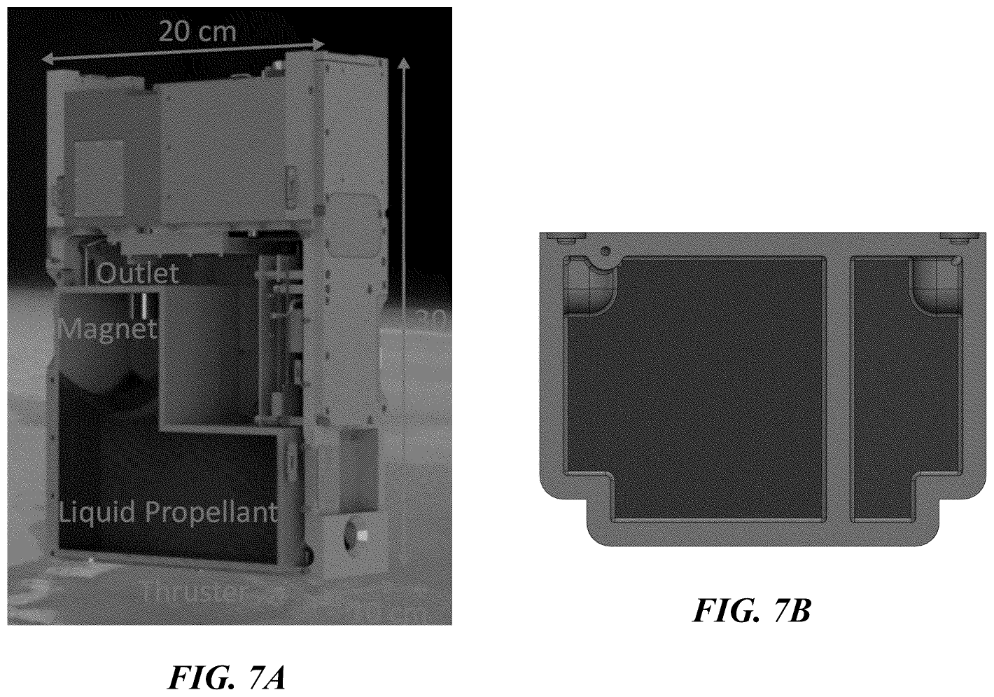

FIG. 7A shows an example CubeSat which may integrate a propellant management system of this disclosure. The CubeSat shown is a 6 U CubeSat with an L-shaped 3 U propellant tank. The propellant tank shown implements the magnetic positive positioning structure with a magnet disposed adjacent to the outlet of the tank.

CubeSat propulsion is further complicated by the use of saturated propellant mixtures, which are popular due to their volumetric efficiency and self-pressurization. When the gas phase is drawn from the tank, the remaining liquid begins to vaporize until the equilibrium pressure is reached. Vaporization occurs throughout the container and further complicates the separation of phases by generating multiple small-diameter gas bubbles.

Alternative methods and devices have been developed to address these issues with saturated propellant mixtures. Such methods and devices rely on a two-tank system to separate the liquid and vapor phases of the working fluid. A main tank is used to store the majority of the propellant as a saturated liquid-vapor mixture, while a plenum is employed to store a smaller volume of gas. An example of a 0.5 U propulsion system using this architecture is shown in FIG. 7B. Vapor is drawn from the plenum for thruster actuation. As the pressure in the plenum decreases, it must be replenished from the main tank. The exact mechanism that allows the plenum to be replenished varies between manufacturers. Some implement just a solenoid valve, while others use a flow control valve along with a heat exchanger to ensure liquid propellant is vaporized en route to the plenum. The latter can refill the plenum more quickly and can allow for continuous operation at the expense of increased power usage and complexity. The former requires the propulsion system to cease firing when refilling the plenum to ensure that all liquid propellant in the plenum is vaporized before resuming thruster actuation. Regardless of the plenum refill mechanism, the two-tank system is inherently volumetrically inefficient. The propellant can be stored as a liquid, and any volume devoted to the storage of gas reduces the overall propellant mass that can be contained within a given volume and the resulting spacecraft ΔV. The inefficiency of storing gas is demonstrated by the fact that the saturation density of the liquid is nearly 200 times that of the vapor at low operating temperatures. As shown in FIG. 7B, vapor storage can occupy a significant portion of the total volume of CubeSat-scale propulsion systems when using two-tank PMDs. Additionally, these propellant management systems are known to fail by allowing liquid to exist within the plenum, leading to unpredictable performance. Their high volume and power requirements, coupled with their lack of reliability, drive the search for an improved propellant management architecture. Such problems are solved with the propellant management systems of this disclosure.

### Experimental Results and Background Research

In a microgravity environment and without the presence of perturbing forces, the fluid geometry within a propellant tank is governed by wettability. Analytical methods for determining the equilibrium, stability, and dynamic response of liquid interfaces exist for axisymmetric tank geometries. However, CubeSat propulsion systems do not generally have geometrically simple propellant tanks. In these cases, the propellant position can only be determined experimentally or computationally.

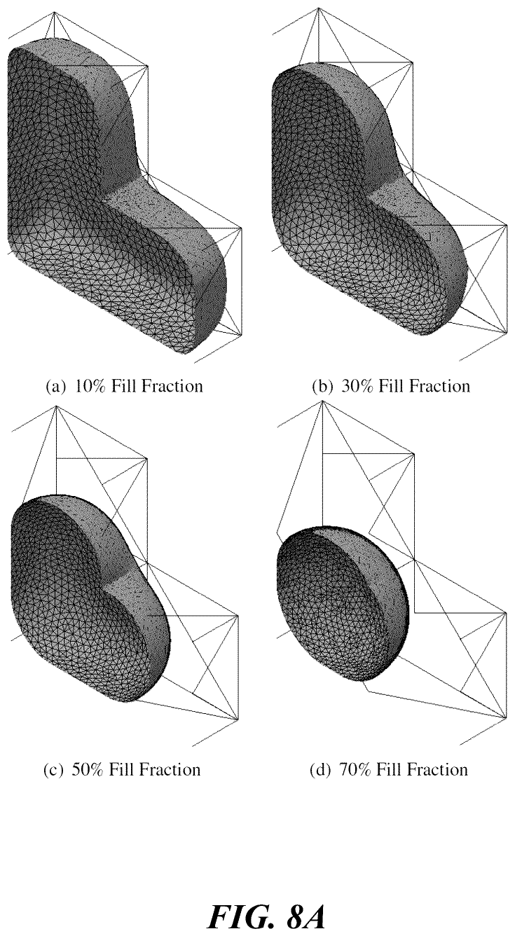

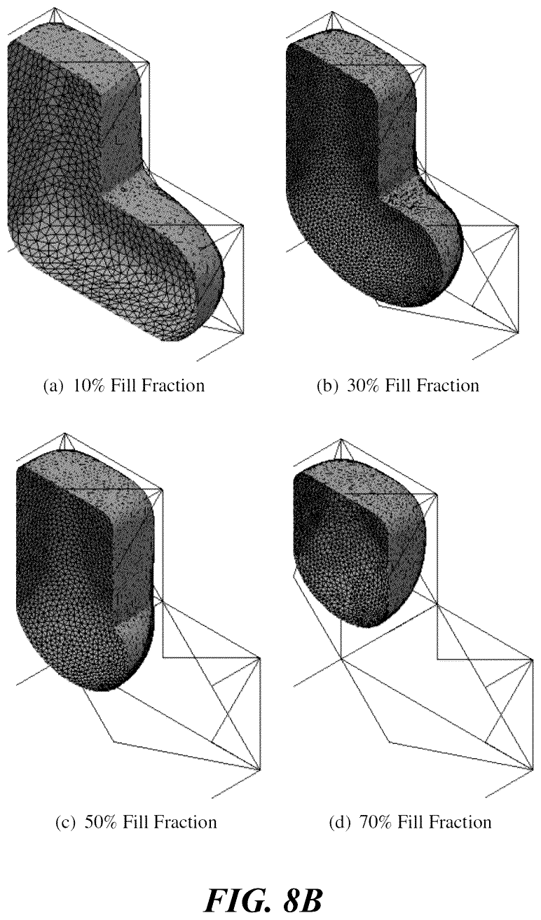

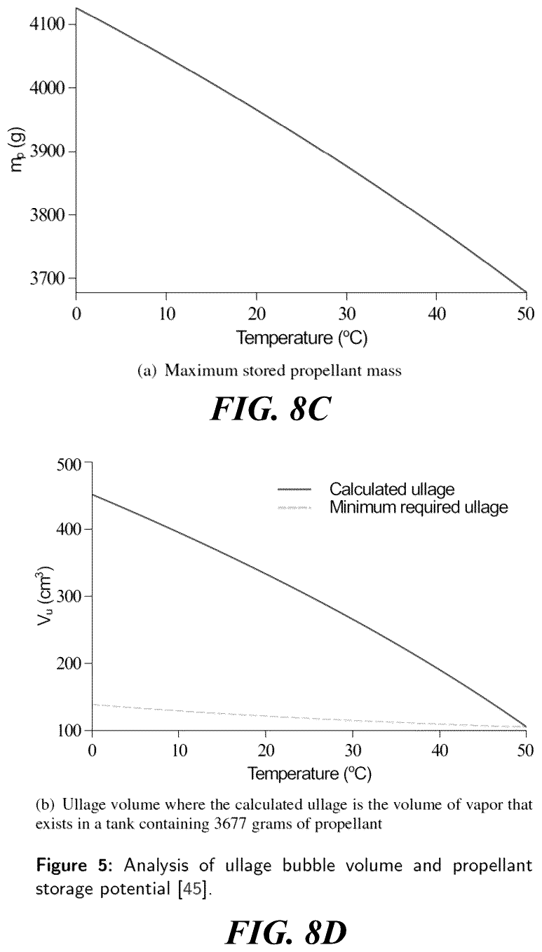

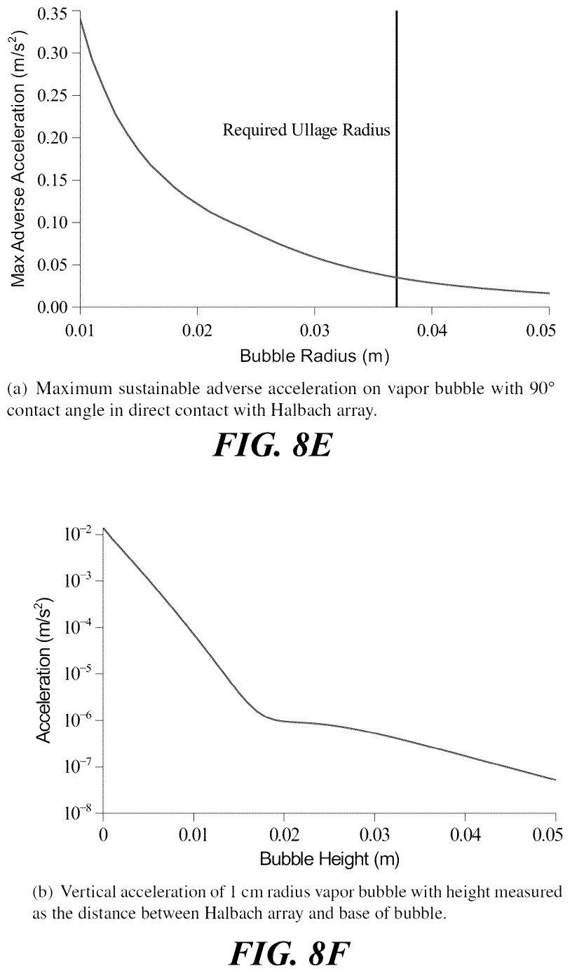

The Surface Evolver—Fluid Interface Tool (SE-FIT) allows for the minimum energy fluid surface to be computed. Surface Evolver has become the standard for propellant positioning analysis in microgravity. Using this software package, the minimum energy fluid geometry is computed for a variety of liquid fill fractions, assuming a perfectly wetting propellant with a zero-degree contact angle. The results of these simulations are shown in FIG. 8A. In the absence of any external forces, the gas bubble positions itself in the center of the tank so long as there is an energy gradient to drive it there. This is expected, given the nature of the tank geometry. The center of the tank allows the bubble to reach the nearest approximation to a sphere for the majority of fill ratios, and a sphere having the minimum surface area for a given bubble volume results in it providing the minimum energy solution. When the gas bubble is sufficiently small such that it can potentially form a sphere in multiple positions in the propellant tank, any one of those solutions is equally likely. This is the case when the gas bubble occupies a volume of less than 523 cm³. Based on the results shown in FIG. 8A, one may initially conclude that a propellant outlet placed at the mid-section or “elbow” of the tank could consistently extract vapor from the propellant tank for any fill fraction less than approximately 70%. While this may be true in the absence of any perturbing forces, it ceases to be the case when the spacecraft begins to accelerate.

In order to simulate the position of the gas bubble when the propulsion system is actuated, it is assumed that a thrust of 15 mN is imparted. In this case, SE-FIT is used to minimize the total energy of the system, accounting for both surface tension and the acceleration of the spacecraft. The results of these simulations are shown in FIG. 8B. Under these conditions, with a Bond number of 1.7, the bubble position is no longer determined purely by wettability. Instead, the bubble position is now largely governed by the 1.25 mm/s² acceleration of the spacecraft, a=T/msc, and it resides near the top of the tank. The gas bubble does not reach the middle of the tank until the liquid propellant fill ratio decreases to nearly 50%, as shown in FIG. 8B, panel (c).

This presents a problem. For the propulsion system to properly function, it must draw a single-phase gas from the propellant tank, but the position of the gas varies depending on whether the propulsion tank is currently accelerating. Additionally, it takes a finite time for the gas bubble to reach equilibrium as it transitions between these two states. A method of actively positioning the bubble over the propellant outlet is required for this system to operate nominally. The logical positions for the outlet are near the center of the tank, where the propellant bubble naturally exists in the absence of perturbations, or near the top of the tank, where the bubble naturally resides during thruster actuation. The top of the tank is chosen to avoid competition between the PMD and the forces experienced during thruster actuation. The methods used to maintain the vapor bubble over this chosen position are described throughout this disclosure.

Ullage Volume Analysis. To ensure that a single-phase gas can be reliably extracted from the propellant tank, the gas bubble must be actively positioned near the outlet. The minimum required tank ullage must be calculated to size a hypothetical PMD. As gas is extracted from the ullage bubble, the liquid propellant, stored as a saturated mixture, begins to vaporize. Small bubbles nucleate on the walls and grow until they reach a critical diameter, at which they detach and begin to rise toward the top of the tank. The formation and rise of the bubbles take a finite amount of time, during which the liquid level in the tank rises as the bubbles displace the liquid. When the bubbles reach the top of the tank, a pseudoequilibrium liquid level is established. It is critical that this interface level be low enough so that no liquid is extracted from the tank. This is ensured by establishing a minimum required amount of ullage volume.

To calculate the required ullage in the tank, the rate at which gas is extracted is first determined by calculating the mass flow rate of propellant out of the thruster nozzle per Equation 1.

$$\dot{m} = \frac{T}{9.81 {I}_{sp}} \qquad ( Eq . 1 )$$

In Equation 1, specific impulse, Iₛₚ, and thrust, T, are analytically determined. The volumetric flor rate of gas from the tank is then determined per Equation 2.

$$q = \frac{\dot{m}}{{ρ}_{g}} \qquad ( Eq . 2 )$$

In Equation 2, ρ_{g} is the saturation density of the gas, which is vaporized from the liquid to compensate for the outflow of propellant.

As the remaining mass of propellant decreases, the volume of liquid decreases, and inversely, the total volume of vapor increases. The volumetric rate at which gas is generated to account for these combined effects when firing, \dot{ω}_{g}, is defined by Equation Set 3.

$${\dot{ω}}_{g} {ρ}_{g} = \dot{m} + \frac{{dV}_{u}}{dt} {ρ}_{g} \\ where \\ \frac{{dV}_{u}}{dt} = \frac{\dot{m}}{{ρ}_{l} - {ρ}_{g}} \qquad ( Eq . Set 3 )$$

In Equation Set 3,

$$\frac{{dV}_{u}}{dt}$$

is the time rate of change of the ullage volume, and ρ₁ is the saturation density of the liquid. Combining the equations in Equation Set 3 yields Equation 4.

$${\dot{ω}}_{g} = \frac{q {ρ}_{l}}{{ρ}_{l} - {ρ}_{g}} \qquad ( Eq . 4 )$$

To determine the ullage volume, the rate at which bubbles rise to the surface of the tank must be calculated. First, the bubble detachment diameter is estimated from Fritz's equation provided in Equation 5.

$$d = 1.2 θ \sqrt{\frac{σ}{a ( {ρ}_{l} - {ρ}_{g} )}} \qquad ( Eq . 5 )$$

In Equation 5, θ is the contact angle (in rad), a surface tension, and α=T/m_{sc} the acceleration of the spacecraft. The contact angle is arbitrarily assumed to be 20° as experimental values are not readily available.

The terminal velocity of the bubble can be found using a balance of forces between drag, buoyancy, and weight per Equation 6.

$$\frac{1}{2} {ρ}_{l} {u}_{t}^{2} {C}_{d} {π ( \frac{d}{2} )}^{2} = ( {ρ}_{l} - {ρ}_{g} ) \frac{4}{3} {π ( \frac{d}{2} )}^{3} a \qquad ( Eq . 6 )$$

In Equation 6, uₜ is the terminal (or steady-state) bubble velocity, and the drag coefficient C_{d}, is calculated per Equation Set 7.

$$log {C}_{d} = 1.6435 - 1.1242 log Re + 0.1558 {( log Re )}^{2} \\ Re = \frac{{ρ}_{l} {U}_{t} d}{{μ}_{l}} \qquad ( Eq . Set 7 )$$

In Equation Set 7, μₗ is the dynamic viscosity of the liquid. Equation 8 assumes that the bubbles act as rigid spheres, and the Reynolds number, Re, remains in the 260-1500 range. These assumptions hold in the presence of impurities in the propellant, and the calculated Re varies from 1031 to 1413.

The necessary ullage volume in the tank can be finally computed per Equation 8.

$${V}_{u} = {\dot{ω}}_{g} \frac{h}{{u}_{t}} \qquad ( Eq . 8 )$$

In Equation 8, h represents the liquid column height. This value assumes a worst-case scenario where all bubbles are generated at the bottom of the tank and move upward unaffected by any forces aside from drag and buoyancy. To ensure proper operation, a margin of 50% is applied to the minimum ullage volume computed from Eq. 8.

Because the propellant is stored as a saturated mixture, the pressure in the tank varies significantly with temperature. The maximum mass of propellant that can be stored in the propellant tank per Equation 9.

$${m}_{p} = {ρ}_{g} {V}_{u} + {ρ}_{l} ( {V}_{t} - {V}_{u} ) \qquad ( Eq . 9 )$$

In Equation 9, Vₜ is the propellant tank volume. The saturation densities of the propellant are tabulated and can be accessed using the CoolProp reference library.

Maximum propellant storage mass and minimum required ullage volume are shown in FIGS. 8C and 8D as a function of the expected operating temperature range of the propulsion system. As shown in FIG. 8C, the propulsion system can only contain 3677 g of propellant at the worst-case operating temperature. This is the maximum mass that can be loaded into the propellant tank before flight to ensure that the minimum required ullage volume is maintained. When this mass of propellant is loaded, the system has a minimum ullage volume of 106 cm³ at 50° C. At any temperature below 50° C., the ullage volume is larger than this and exceeds the minimum required ullage volume, as illustrated in FIG. 8D, where the ullage volume is determined by solving for Vᵤ in Equation 9, with mₚ being 3677 g for this example.

Magnetic Force on Vapor Bubble. With regard to the magnetic positive positioning structure of this disclosure, a study was conducted to analyze the magnetic force and acceleration on the two-phase liquid-vapor propellant.

The force on a vapor bubble is analyzed in two separate scenarios. The first involves a bubble making physical contact with the Halbach array with a contact angle of 90°, effectively forming a hemispherical interface. This configuration experiences a force due to the gradient of the magnetic field as well as a separate force at the contact line due to surface tension, F_{σ}=2πRσ, with R being the radius of the hemispherical bubble and a being the surface tension of the liquid.

Using these two contributions, the maximum adverse acceleration that can be withstood while maintaining the bubble position is calculated. The results in FIG. 8E show that the maximum acceleration that can be withstood decreases rapidly with bubble radius. This is partially because the force due to the magnetic field decreases as the distance from the magnets increases, as shown in FIGS. 2E and 2F. This results in larger bubbles experiencing a smaller force density. Additionally, the force due to surface tension scales linearly with the radius of the bubble, while the force due to the perturbing acceleration scales with the bubble volume or R³.

The acceleration of a static 1 cm radius bubble is also analyzed to determine the effectiveness of the device on a bubble that is not already in contact with the Halbach array. For this analysis, the bubble is assumed to be spherical and positioned vertically above the center of the Halbach array. The acceleration experienced by the bubble is shown in FIG. 8F as a function of its height as measured from the bottom of the bubble. The acceleration decreases rapidly, but not in the smooth way one might expect. This is due to the shape of the acceleration field generated by the Halbach array, which can be seen in FIG. 2F. The shape of the field is a result of the spacing of the magnets within the array.

As indicated previously, the magnitude of acceleration decreases rapidly as the distance from the magnet increases. The presence of the magnet near a liquid-vapor mixture induces phase separation by attracting the gas. However, if the gas phase is sufficiently separated from the outlet, the magnetic force becomes too weak to induce any meaningful effect. As shown in FIG. 8F, the acceleration rapidly decays to values below the microgravity level as the bubble moves away from the array. As previously discussed, one possible method to improve the operation of an MPP system is to use a ferromagnetic propellant.

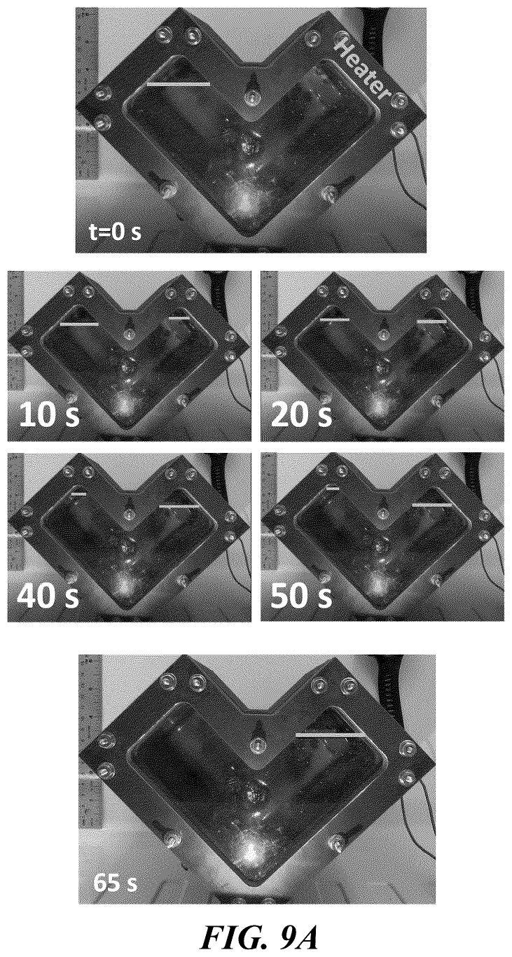

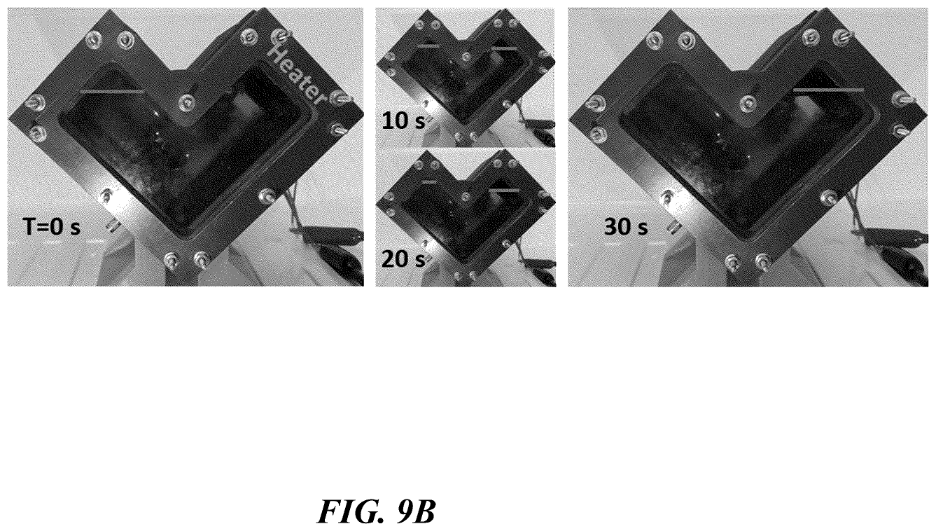

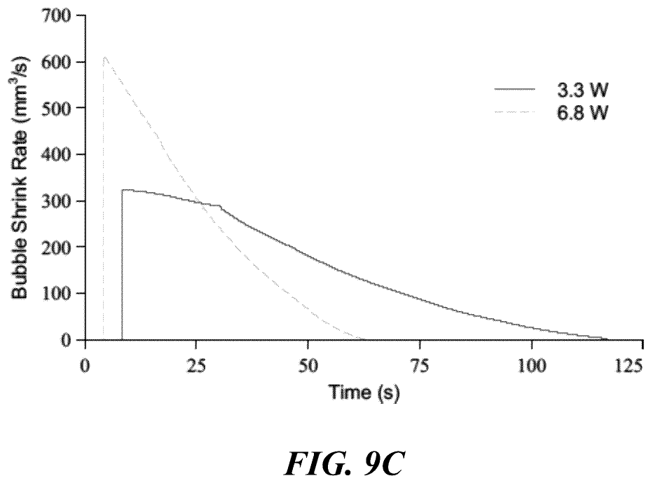

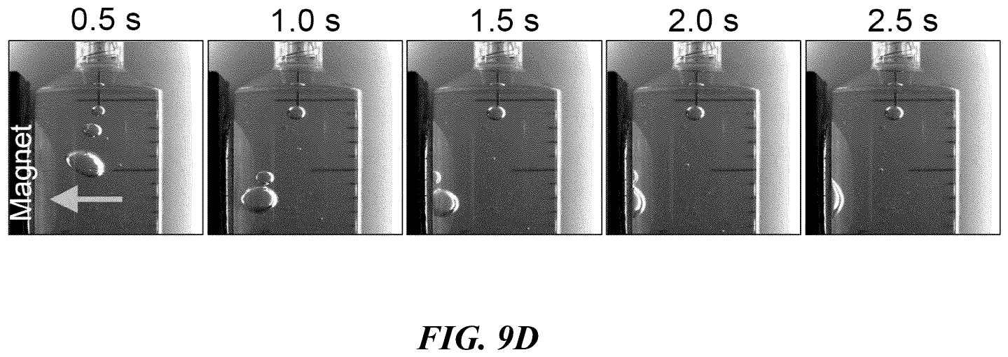

Testing Results. FIG. 9A shows a series of images over time depicting a prototypical propellant tank of the present disclosure used for testing (e.g., parabolic flight testing or ground tests). The tank is filled with a two-phase liquid-vapor propellant (e.g., R-236fa) and includes a heater on one side (e.g., adjacent to an outlet). The heater used is a 6.5 W phase-change thermal propellant management device.

As shown, the first panel at t=0 seconds includes a line marking the interface between the liquid portion and the vapor portion of the two-phase propellant. The interface line is only on the side distal from the heater at t=0 s. However, as the experiment progresses and a thermal gradient is established within the tank, a second interface forms adjacent to the heater. Some of this occurs from the generation of vapor in the tank, and some of this occurs from the repositioning of existing vapor. At t=65 seconds, all of the vapor has moved to the side of the tank having the heater, completing the propellant management operation.

FIG. 9B is another prototypical propellant tank used for testing procedures (e.g., ground tests). In FIG. 9B, a series of images are shown displaying a phase-change and vapor repositioning process for R-236fa propellant using a thermal management device (heater). The evolution and repositioning of the vapor bubble is shown as heat is applied using the heater. In this test, 17 W was employed to speed up the process and satisfy time constraints of a parabolic flight test. In other implementations, the system may use only 5 W of power.

FIG. 9C shows a graph depicting the preliminary effects of power input over time on bubble shrink rate. The graph shows results from two tests performed in the same tank with the same bubble volume. Shown are two scenarios, one for 3.3 W and one for 6.8 W. As shown, the bubble shrink rate for the higher power scenario begins at a higher point, but it then decreases quickly, moving slower than the lower power scenario after roughly 35 seconds. The higher power test not only starts with a higher shrink rate, but it also fully shrinks (i.e., condenses) the bubble in roughly 60 seconds as compared to approximately 120 in the lower power test. This trend shows that the higher power results in more rapid propellant positioning. The decrease in shrink rate throughout the test is caused by a number of factors including decreased contact area between the liquid and the heat source and convection developing within the fluid.

FIG. 9D shows a series of images over time depicting microgravity tests. The microgravity tests show the displacement and coalescence of gas bubbles injected into a diamagnetic liquid when exposed to the magnetic field of a neodymium magnet. This test verifies the applicability of MPP propellant management systems.

### Example Computing System

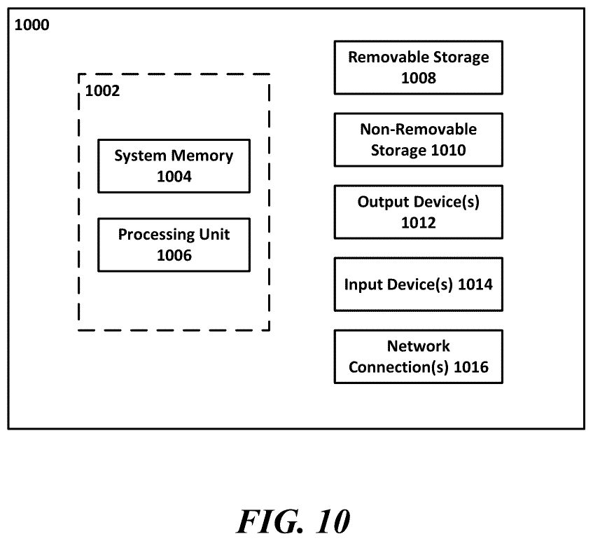

FIG. 10 shows an example controller, or an example computing device 1000 upon which the methods described herein may be implemented are illustrated. It should be understood that the example computing device 1000 is only one example of a suitable computing environment upon which the methods described herein may be implemented. Optionally, the computing device 1000 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 1000 typically includes at least one processing unit 1006 and system memory 1004. Depending on the exact configuration and type of computing device, system memory 1004 may be volatile (such as random access memory (RAM)), non-volatile (such as read-only memory (ROM), flash memory, etc.), or some combination of the two. This most basic configuration is illustrated in FIG. 10 by dashed line 1002. The processing unit 1006 may be a standard programmable processor that performs arithmetic and logic operations necessary for the operation of the computing device 1000. The computing device 1000 may also include a bus or other communication mechanism for communicating information among various components of the computing device 400.

Computing device 1000 may have additional features/functionality. For example, computing device 1000 may include additional storage such as removable storage 1008 and nonremovable storage 1010, including, but not limited to, magnetic or optical disks or tapes. Computing device 1000 may also contain network connection(s) 1016 that allow the device to communicate with other devices. Computing device 1000 may also have input device(s) 1014 such as a keyboard, mouse, touch screen, etc. Output device(s) 1012, such as a display, speakers, printer, etc., may also be included. The additional devices may be connected to the bus in order to facilitate the communication of data among the components of the computing device 1000. All these devices are well-known in the art and need not be discussed at length here.

The processing unit 1006 may be configured to execute program code encoded in tangible, computer-readable media. Tangible, computer-readable media refers to any media that is capable of providing data that causes the computing device 1000 (i.e., a machine) to operate in a particular fashion. Various computer-readable media may be utilized to provide instructions to the processing unit 1006 for execution. Examples of tangible, computer-readable media may include, but are not limited to, volatile media, non-volatile media, removable media, and nonremovable media implemented in any method or technology for storage of information such as computer-readable instructions, data structures, program modules or other data. System memory 1004, removable storage 1008, and non-removable storage 1010 are all examples of tangible, computer storage media. Examples of tangible, computer-readable recording media include, but are not limited to, an integrated circuit (e.g., field-programmable gate array or application specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 1006 may execute program code stored in the system memory 1004. For example, the bus may carry data to the system memory 1004, from which the processing unit 1006 receives and executes instructions. The data received by the system memory 1004 may optionally be stored on the removable storage 1008 or the non-removable storage 1010 before or after execution by the processing unit 1006.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and it may be combined with hardware implementations.

### General Definitions

The construction and arrangement of the systems and methods as shown in the various implementations are illustrative only. Although only a few implementations have been described in detail in this disclosure, many modifications are possible (e.g., variations in sizes, dimensions, structures, shapes, and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

The following patents, applications and publications as listed below and throughout this document are hereby incorporated by reference in their entirety herein.

### REFERENCE LIST

[1] T. Villela, C. A. Costa, A. M. Brand\tilde{ }ao, F. T. Bueno, and R. Leonardi, “Towards the Thousandth CubeSat: A Statistical Overview,” International Journal of Aerospace Engineering, Vol. 2019, January 2019, pp. 1-13, 10.1155/2019/5063145.
[2] R. Agarwal, B. Oh, D. Fitzpatrick, A. Buynovskiy, S. Lowe, C. Lisy, A. Kriezis, B. Lan, Z. Lee, A. Thomas, B. Wallace, E. Costantino, G. Miner, J. Thayer, S. D'Amico, K. Lemmer, W. Lohmeyer, and S. Palo, “Coordinating Development of the SWARM-EX CubeSat Swarm Across Multiple Institutions,” Small Satellite Conference, Logan, UT, August 2021.
[3] A. Koenig, S. D'Amico, and E. G. Lightsey, “Formation Flying Orbit and Control Concept for the VISORS Mission,” AIAA Scitech 2021 Forum, Virtual Event, American Institute of Aeronautics and Astronautics, January 2021, 10.2514/6.2021-0423.
[4] D. Jaekle Jr., “Propellant management device conceptual design and analysis—Sponges,” 29th Joint Propulsion Conference and Exhibit, Monterey, CA, June 1993, 10.2514/6.1993-1970.
[5] D. Jaekle, Jr., “Propellant management device conceptual design and analysis—Vanes,” 27th Joint Propulsion Conference, Sacramento, CA,U.S.A., June 1991, 10.2514/6.1991-2172.
[6] D. Jaekle, r, “Propellant management device conceptual design and analysis—Traps and troughs,” 31^{st} Joint Propulsion Conference and Exhibit, San Diego, CA,U.S.A., July 1995, 10.2514/6.1995-2531.
[7] S. T. Hart, N. L. Daniel, M. C. Hartigan, and E. G. Lightsey, “Design of the 3-D Printed Cold Gas Propulsion Systems for the VISORS Mission,” 2022 AAS GNC Conference, Breckenridge, CO, U.S.A., January 2022.
[8] S. H. Collicott, E. A. Beckman, and P. Srikanth, “Conformal Tanks: Small-Sat Propellant Management Technology,” AIAA Propulsion and Energy 2019 Forum, August 2019, 10.2514/6.2019-3874.
[9] T. Stevenson, E. Glenn Lightsey, and M. Sorgenfrei, “Development and Testing of a 3-D-Printed Cold Gas Thruster for an Interplanetary CubeSat,” Proceedings of the IEEE, Vol. 106, March 2018, pp. 379-390, 10.1109/JPROC.2018.2799898.
[10] T. Stevenson and G. Lightsey, “Design and Characterization of a 3D-Printed Attitude Control Thruster for an Interplanetary 6 U CubeSat,” Small Satellite Conference, Logan, UT, August 2016.
[11] VACCO, “JPL MarCO—Micro CubeSat Propulsion System X14102000-01,” https://cubesatpropulsion.com/wp-content/uploads/2015/11/X14102000-01^{⋅}2019 update.pdf, November 2022.
[12] N. Hejmanowski, C. Woodruff, R. Burton, D. Carroll, and A. Palla, “CubeSat High Impulse Propulsion System (CHIPS) Design and Performance,” 63rd JANNAF Propulsion Meeting, Pheonix, AZ, December 2016.
[13] D. Hinkley, “A Novel Cold Gas Propulsion System for Nanosatellites and Picosatellites,” Small Satellite Conference, Logan, UT, August 2008.
[14] S. T. Hart and E. G. Lightsey, “Improvements on Two-Phase Cold Gas Propulsion Systems for Small Spacecraft,” Breckenridge, CO, February 2023.
[15] D. Sternberg, J. Essmiller, C. Colley, A. Klesh, and J. Krajewski, “Attitude Control System for the Mars Cube One Spacecraft,” 2019 IEEE Aerospace Conference, March 2019, pp. 1-10. ISSN: 1095-323X, 10.1109/AERO.2019.8741816.
[16] A. Romero-Calvo, F. Maggi, and H. Schaub, “Magnetic Positive Positioning: Toward the application in space propulsion,” Acta Astronautica, Vol. 187, 2021, pp. 348-361, 10.1016/j.actaastro.2021.06.045.
[17] E. Scarl and J. Houston, “Two-phase magnetic fluid manipulation in microgravity environments,” Proceedings of the 37th Aerospace Sciences Meeting and Exhibit, 1999, pp. 1-5, 10.2514/6.1999-844.
[18] A. Romero-Calvo, G. Cano-G\acute{ }omez, and H. Schaub, “Diamagnetically Enhanced Electrolysis and Phase Separation in Low Gravity,” AIAA Journal of Spacecraft and Rockets, 2021, pp. 1-13, 10.2514/1.A35021.
[19] S. Papell, “Low viscosity magnetic fluid obtained by the colloidal suspension of magnetic particles,” 1963. U.S. Pat. No. 3,215,572.
[20] J. Martin and J. Holt, “Magnetically Actuated Propellant Orientation Experiment, Controlling fluid Motion With Magnetic Fields in a Low-Gravity Environment,” Tech. Rep. TM-2000-210129, NASA, 2000.
[21] D. Chipchark, “Development of expulsion and orientation systems for advanced liquid rocket propulsion systems,” Tech. Rep. RTD-TDR-63-1048, Contract AF04 (611)-8200, USAF, 1963.
[22] M. R. Pearson and J. Seyed-Yagoobi, “Numerical sturdy of dielectric fluid bubble behavior within diverging external electric fields,” Journal of Heat Transfer, Vol. 130, 2008, 10.1115/1.2804937.
[23] J. R. Melcher, M. Hurwitz, and R. G. Fax, “Dielectrophoretic liquid expulsion,” Journal of Spacecraft and Rockets, Vol. 6, 1969, pp. 961-967, 10.2514/3.29740.
[24] A. Myshkis and R. Wadhwa, Low-gravity fluid mechanics: mathematical theory of capillary phenomena. Springer, 1987.
[25] Y. Chen, B. Schaffer, M. Weislogel, and G. Zimmerli, “Introducing SE-FIT: Surface Evolver—Fluid Interface Tool for Studying Capillary Surfaces,” 49th AIAA Aerospace Sciences Meeting including the New Horizons Forum and Aerospace Exposition, Aerospace Sciences Meetings, January 2011, 10.2514/6.2011-1319.
[26] K. A. Brakke, “The surface evolver,” Experimental Mathematics, Vol. 1, January 1992, pp. 141-165. [27] T. Stevenson, Development of Multi-Functional Structures for Small Satellites. PhD thesis, Georgia Institute of Technology, December 2018.
[28] K. Stephan, Physical Fundamentals of Vapor Bubble Formation, pp. 126-139. 1992, 10.1007/978-3-642-52457-8^{⋅}10.
[29] R. Clift, J. Grace, and M. Weber, Bubbles, Drops, and Particles. Dover Civil and Mechanical Engineering Series, Dover Publications, 2005.
[30] A\acute{ }. Romero-Calvo, O″. Akay, H. Schaub, and K. Brinkert, “Magnetic phase separation in microgravity,” npj Microgravity 2022, Vol. 8, No. 1, 2022, 10.1038/s41526-022-00212-9.
[31] I. H. Bell, J. Wronski, S. Quoilin, and V. Lemort, “Pure and Pseudo-pure Fluid Thermophysical Property Evaluation and the Open-Source Thermophysical Property Library CoolProp,” Industrial & Engineering Chemistry Research, Vol. 53, January 2014, pp. 2498-2508, 10.1021/ie4033999.
[32] M. W. Dowdy and S. C. Debrock, “Selection of a Surface-Tension Propellant Management System for the Viking 75 Orbiter,” Journal of Spacecraft and Rockets, Vol. 10, September 1973, pp. 549-558, 10.2514/3.61925.
[33] M. M. Hasan, C. S. Lin, R. H. Knoll, and M. D. Bentz, “Tank Pressure Control Experiment: Thermal Phenomena in Microgravity,” March 1996. NTRS Author Affiliations: NASA Lewis Research Center, Analex Corp., Boeing Defense and Space Group NTRS Report/Patent Number: NAS 1.60:3564 NTRS Document ID: 19960017263 NTRS Research Center: Legacy CDMS (CDMS).
[34] Romero-Calvo, V. Urbansky, V. Yudintsev, H. Schaub, and V. Trushlyakov, “Novel propellant settling strategies for liquid rocket engine restart in microgravity,” Acta Astronautica, Vol. 202, January 2023, pp. 214-228, 10.1016/j.actaastro.2022.10.012.
[35] A. Romero-Calvo, G. Cano-G\acute{ }omez, E. Castro-Hern\acute{ }andez, M. A. Herrada-Guti\acute{ }errez, and F. Maggi, “Magnetic Sloshing Damping in Microgravity,” 8th Interplanetary CubeSat Workshop, Milan, Italy, 2019.
[36] A. Romero-Calvo, G. Cano-G\acute{ }omez, T. H. Hermans, L. Parrilla Ben\acute{ }itez, M. Herrada, and E. Castro-Hern\acute{ }andez, “Total magnetic force on a ferrofluid droplet in microgravity,” Experimental Thermal and Fluid Science, Vol. 117, 2020, p. 110124, 10.1016/j.expthermflusci.2020.110124.
[37] J. Melcher, Continuum Electromechanics. MIT Press, 1981.
[38] T. B. Jones and G. W. Bliss, “Bubble dielectrophoresis,” Journal of Applied Physics, Vol. 48, 1977, pp. 1412-1417, 10.1063/1.323806.
[39] J. B. Blackmon, “Collection of liquid propellants in zero gravity with electric fields,” Journal of Spacecraft and Rockets, Vol. 2, 1965, pp. 391-398, 10.2514/3.28190.
[40] A. P. Ribeiro and C. A. N. D. Castro, “Dielectric properties of liquid refrigerants: Facts and trends,” International Journal of Refrigeration, Vol. 34, March 2011, pp. 393-401, 10.1016/j.ijrefrig.2010.11.007.

What is claimed is:

1. A system for fluid management in low- or micro-gravity environment, the system comprising:
a two-phase gas-liquid tank suitable for storage of a two-phase gas-liquid, the two-phase gas-liquid tank comprising an outer surface, an inner cavity, and an outlet between the inner cavity and the outer surface;
a thermal or electromagnetic device disposed on or proximal to the two-phase gas-liquid tank; and
a controller operatively coupled to the thermal or electromagnetic device, the controller being configured to energize the thermal or electromagnetic device in a controlled manner (i) to generate a thermal or electromagnetic gradient in the two-phase gas-liquid and (ii) urge a portion of the two-phase gas-liquid to the outlet of the two-phase gas-liquid tank.

2. The system of claim 1, wherein the thermal or electromagnetic device is a thermal device disposed proximal to the outlet, wherein the controller is configured to cause the thermal device to vaporize a portion of the two-phase gas-liquid near to the outlet of the two-phase gas-liquid tank to generate a vapor output of the two-phase gas-liquid at a pre-defined rate.

3. The system of claim 2, wherein the pre-defined rate corresponds to a controlled mass flow rate of the vapor output as a propellant for a propulsion system.

4. The system of claim 1, wherein the thermal or electromagnetic device is a thermal device disposed distal from the outlet, wherein the controller is configured to cause the thermal device to vaporize a portion of the two-phase gas-liquid far from the outlet of the two-phase gas-liquid tank to generate a liquid output of the two-phase gas-liquid at a pre-defined rate.

5. The system of claim 1, wherein the two-phase gas-liquid tank asymmetrically has two or more elongated portions each having a center axis that are non-parallel to one another.

6. The system of claim 1 further comprising: a plurality of capillary panels disposed in the inner cavity extending from the outlet to an opposite side of the inner cavity, each of the plurality of capillary panels having a curvature at a top face to define a small gap adjacent to the outlet, wherein a vapor bubble formed of the two-phase gas-liquid is urged towards or maintained within the small gap.

7. The system of claim 1, wherein the thermal or electromagnetic device comprises one or more resistive heating elements arranged in a pattern to produce a thermal gradient across the inner cavity.

8. The system of claim 1, wherein the two-phase gas-liquid tank includes a set of pocket protrusions in the inner cavity, the set of pocket protrusions comprising a heater element.

9. The system of claim 1, wherein the thermal or electromagnetic device comprises a heat exchanger operatively coupled to an exhaust duct or pipe for propellant vaporization.

10. The system of claim 1, wherein the thermal or electromagnetic device is positioned within the two-phase gas-liquid tank.

11. The system of claim 1, wherein the thermal or electromagnetic device is fixably attached to the outer surface of the two-phase gas-liquid tank proximal to the outlet.

12. The system of claim 1, wherein the thermal or electromagnetic device comprises a dielectrophoresis (DEP) subsystem having at least one electrode positioned in the inner cavity and configured to impart a dielectric buoyancy force on the two-phase gas-liquid inside the tank, which results in phase separation such that (i) a vapor output is urged towards the outlet and a liquid is directed away from the outlet, or (ii) the liquid output is urged towards the outlet and the vapor is directed away from the outlet,
wherein a first phase of the two-phase gas-liquid has a first dielectric property, and wherein a second phase of the two-phase gas-liquid has a second dielectric property, the first and the second dielectric property being different from one another.

13. The system of claim 1 further comprising:
one or more magnets positioned proximal to the outlet, the one or more permanent magnets configured to impart a magnetic or electromagnetic buoyancy force on the two-phase gas-liquid to cause directional phase separation by urging one of a vapor or a paramagnetic or diamagnetic liquid of the two-phase gas-liquid towards the outlet and the other of the vapor or the paramagnetic liquid of the two-phase gas-liquid away from the outlet.

14. The system of claim 1 further comprising:
one or more storage tanks coupled to an output of the two-phase gas-liquid tank, wherein the one or more storage tanks feed a propulsion system or a life support system.

15. The system of claim 1, wherein the controller is configured to adjust energization of the thermal or electromagnetic device, wherein energization of the thermal device is configured to increase generation of a vapor output as volume of the two-phase gas-liquid decreases.

16. The system of claim 1, wherein the controller is configured to (i) determine a required vapor output rate and (ii) determine a required ullage in the two-phase gas-liquid tank for the required vapor output rate by calculating a rate of vapor output generation and disposition to the outlet.

17. The system of claim 1, wherein the system is configured for integration with a small satellite propulsion system, wherein the two-phase gas-liquid tank comprises an asymmetric volume, and wherein the two-phase gas-liquid comprises a propellant.

18. The system of claim 1, wherein the system is configured for integration with a life support system.

19. The system of claim 1, wherein the two-phase gas-liquid tank and outlet have an inertia-induced separation configuration comprising the outlet being disposed along a vehicle direction of travel to apply inertia force to the two-phase gas-liquid opposite to the vehicle direction of travel and urge a vapor output towards the outlet.

20. The system of claim 1, wherein the two-phase gas-liquid comprises ferromagnetic particles.

21. A non-transitory computer-readable medium having instructions stored thereon for execution of a controller for a fluid management system in low or microgravity environment, wherein the fluid management system includes a two-phase gas-liquid tank suitable for storage of a two-phase gas-liquid, the two-phase gas-liquid tank comprising an outer surface, an inner cavity, and an outlet between the inner cavity and the outer surface, a thermal or electromagnetic device disposed proximal to the two-phase gas-liquid tank; and a controller operatively coupled to the thermal or electromagnetic device, the controller being configured to energize the thermal or electromagnetic device in a controlled manner (i) to generate a thermal or electromagnetic gradient heat in the two-phase gas-liquid and (ii) vaporize, via the thermal device, a portion of the two-phase gas-liquid near the outlet of the two-phase gas-liquid tank to generate a vapor output of the two-phase gas-liquid at a pre-defined rate,
wherein execution of the instructions by a processor causes the processor to:
determine a required vapor output rate; and
determine a required ullage in the two-phase gas-liquid tank for the required vapor output rate by calculating a rate of vapor output generation and disposition to the outlet.

22. A system for fluid management in low or microgravity environment, the system comprising:
a two-phase gas-liquid tank suitable for storage of a two-phase gas-liquid, the two-phase gas-liquid tank comprising an outer surface, an inner cavity, and an outlet between the inner cavity and the outer surface; and
one or more permanent magnets positioned proximal to the outlet, the permanent magnet configured to impart a magnetic or electromagnetic buoyancy force on the two-phase gas-liquid to cause directional phase separation such that one of a vapor or a liquid of the two-phase gas-liquid is urged towards the outlet and the other of the vapor or the liquid of the two-phase gas-liquid is directed away from the outlet.
